(19) United States
(12) Patent Application Publication
(10) Pub. No.: US 2026/0336096 A1
(43) Pub. Date: Oct. 29, 2026

(54) DEXTEROUS ROBOTIC MANIPULATOR SYSTEMS

(71) Applicant: Daxo Industries, Inc., Austin, TX (US)

(72) Inventors: Jiahao Zhang, Austin, TX (US); Haoyun XU, Austin, TX (US)

(73) Assignee: Daxo Industries, Inc., Austin, TX (US)

(21) Appl. No.: 19/656,384

(22) Filed: Apr. 23, 2026

Related U.S. Application Data
(60) Provisional application No. 63/795,047, filed on Apr. 25, 2025.

(51) Int. Cl. B25J 9/10; B25J 9/06

(52) U.S. Cl. CPC B25J 9/1075; B25J 9/065

(57) ABSTRACT

A robotic manipulator system that includes a robotic appendage and an actuator grid. The robotic appendage includes a support structure, a series of discs arranged along a longitudinal axis of the support structure, and a plurality of tendons extending through the series of discs, wherein a distal end of each tendon of the plurality of tendons is attached to the series of discs. The actuator grid includes an arrangement of 35 or more actuators, each actuator of the 35 or more actuators engaging one or more proximal ends of one or more tendons of the plurality of tendons. The robotic manipulator system can include a gripper including a plurality of robotic appendages.

### REFERENCE TO RELATED APPLICATIONS

This application claims the benefit of U.S. Provisional Application No. 63/795,047, filed Apr. 25, 2025, entitled “Dexterous Robotic Manipulator Systems.” The benefit under 35 USC § 119(e) of the United States provisional application is hereby claimed, and the aforementioned application is hereby incorporated herein by reference in its entirety.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### FIELD

The present disclosure relates generally to robotic systems, and more specifically to robotic systems capable of dexterous manipulation.

### BACKGROUND

Despite rapid advances in automation, conventional robotic systems are still incapable of performing a vast number of tasks. These tasks, referred to as the “last miles of automation” are tasks that automation has yet to reach, not because of a lack of effort, but because of the fundamental limitations of conventional robotic hardware and control methods. The challenge is not merely one of productivity but of fundamental robotic capability. For example, some last mile tasks include chicken deboning, fabric and plastic post-processing, wire harness assembly, and other intricate, dexterous tasks that remain beyond the reach of conventional robots. Generally speaking, two themes unite these last-mile tasks: (1) they require highly dexterous manipulation and (2) they involve handling deformable objects, where traditional automation struggles.

The need for human workers to perform these last mile tasks persists not because of economic efficiency but because conventional robots have failed to provide a viable alternative. Rising labor costs and poor working conditions only heighten the urgency. For example, in some industries (e.g., plastic manufacturing), young workers toil for 10-hour shifts in 90-degree heat without air conditioning—a problem that automation should have solved by now.

Numerous entities are attempting to solve robot dexterity, but the robotic hands developed by these companies are extremely limited in their number of degrees of freedom, which range from 16-24. The approaches to solving robotic dexterity adopted by these companies largely fall into three categories. One conventional approach to increasing dexterity of robotic systems includes using biomimetic hardware with electric motors. This approach assumes that mimicking human morphology—whether full-body or hand-based—is the key to dexterity. However, these systems typically have series-stacked motors, which create single points of failure, such that if one motor breaks, the entire system is compromised. Further, series-stacking of motors limits the payload of each finger. In robotic fingers where motors are very small, the motors often break down due to overheating (e.g., overloaded by external forces) or from mechanical drops. Additionally, miniaturizing motors for robotic fingers limits power density of the motors and drives up production costs. The dedication to mimicking human morphology also creates limitations. For example, the focus on both bipedal locomotion and dexterity spreads resources thin, even though in industrial settings, wheels are often sufficient.

Another conventional approach includes using biomimetic hardware with tendon-driven or other non-traditional actuators. While these approaches can demonstrate superior dexterity over electric motors, cost and reliability challenges have hindered widespread adoption. For example, the use of non-standard actuators is cost-prohibitive since non-standard actuators lack economies of scale. Further, adherence to human-like morphology constrains design potential, preventing breakthroughs in dexterity.

A third conventional approach focuses on combining artificial intelligence with existing robotic hardware. This approach assumes that existing hardware is already sufficient and that the missing piece is advanced intelligence. Proponents of this approach believe that robotics lacks an artificial intelligence breakthrough and that by training large foundation models, robots will unlock new levels of dexterity. Adherents to this approach focus exclusively on data collection, treating data as the primary bottleneck. However, the belief that existing hardware is sufficient and only artificial intelligence is needed is flawed. For example, no current robotic hand can debone a chicken at industrial throughput levels, no matter what kind of artificial intelligence is used to control it. Additionally, the lack of clear guidelines on what constitutes good quality data makes scaling learning-based approaches difficult.

Accordingly, there is a need for robotic systems capable of dexterous manipulation and of handling deformable objects that reflect a radical departure from conventional robotic paradigms.

### SUMMARY

The robotic manipulator systems disclosed herein reflect a fundamental rethinking of robotic design and control to achieve dexterity on par with or surpassing human capabilities. The disclosed systems may be the result of a paradigm shift in how robots are conceived, built, and programmed. The disclosed robotic manipulator systems reflect a willingness to abandon human mimetics, embrace complexity, and may be the result of a principled, task-driven approach to robotic development. Described herein are robotic manipulator systems that can demonstrate three core principles: ultra-redundancy, deep-learning based control, and/or morphology free design. The robotic systems disclosed herein may have more degrees of freedom than current systems. Further, the machine learning systems driving the control of the robotic systems may be directly coupled with the high-dimensional actuation achieved by the robotic systems disclosed within. Additionally, the hardware of the disclosed robotic manipulator systems can be designed for function, and may not be constrained by human resemblance as a design factor.

Described herein are highly dexterous robotic manipulator systems that can be capable of performing tasks that conventionally require human labor. By incorporating a large number of individually actuated tendons (e.g., 30 or more, 35 or more, 40 or more, 50 or more, 60 or more, 100 or more, 200 or more, 300 or more, 900 or more, 1000 or more) per robotic appendage, the robotic manipulator systems can achieve between a corresponding large number of degrees of freedom (e.g., 30 or more, 35 or more, 40 or more, 50 or more, 60 or more, 100 or more, 200 or more, 300 or more, 900 or more, 1000 or more) per robotic appendage. As described further herein, the robotic manipulator systems may be able to incorporate the large number of individually actuated tendons by way of strategic bundling of the large number of tendons and reduced space constraints enabled by the separation of actuators and robotic appendages. Further, the described systems may be able to individually actuate each of the tendons due to strategic gathering of the tendons as they are routed into the robotic appendages. The described robotic manipulator systems can be used in a variety of industries, including manufacturing, assembly, food processing, agriculture, medical robotics, prosthetics, human augmentation, space travel, and consumer robotics. For example, the described systems can execute tasks such as deboning a chicken, performing surgery, endoscopy, wire harness manufacturing, cooking, sheet metal deburring, or other highly dexterous tasks.

The robotic manipulator systems described herein can include at least one robotic appendage. Each robotic appendage can include a support structure, a series of discs arranged along a longitudinal axis of the support structure, and 35 or more tendons extending through the series of discs with distal ends of the tendons attached to discs of the series of discs. The systems also include at least one actuator grid comprising an arrangement of 35 or more actuators, where each actuator engages a proximal end of a tendon. When the tendons are actuated, tension or compression in the tendons can cause the robotic appendage to move in desired directions. Importantly, the disclosed systems may include strategic gathering of tendons, such that individual tendons do not interfere with actuation of other tendons negatively, even with large numbers of tendons per robotic appendage.

As discussed above, while the disclosed systems can incorporate a large number of individually actuated tendons (e.g., 30 or more, 35 or more, 40 or more, 50 or more, 60 or more, 100 or more, 200 or more, 300 or more, 900 or more, or 1000 or more) due to reduced space constraints enabled by the separation of actuators and robotic appendages. In some embodiments, design limitations (e.g., space constraints in the environment or space constraints due to a given task) may limit the number of individually actuated tendons (e.g. less than 1000, less than 900, less than 800, less than 700, less than 600, less than 300, less than 200, less than 100, less than 60, less than 50, or less than 40) per robotic appendage and/or the number of actuators (e.g. less than 1000, less than 900, less than 800, less than 700, less than 600, less than 300, less than 200, less than 100, less than 60, less than 50, or less than 40) per robotic appendage.

By incorporating a large number (e.g., 30 or more, 35 or more, 40 or more, 50 or more, 60 or more, 100 or more, 200 or more, 300 or more, 900 or more, or 1000 or more) of individually actuated tendons and/or actuators per robotic appendage, the disclosed systems may be highly resilient because the redundant actuators allow the robotic manipulator systems to function even if some actuators fail, which can simplify maintenance. Using a large number of identical actuators can reduce costs due to economies of scale. Further, arranging the actuators in parallel instead of in series may enable a high payload per robotic appendage.

The disclosed systems may also be highly optimized for deep learning control, which can allow deep learning to unlock robotic dexterity in ways previously unattainable. The disclosed systems may have deep learning synergy because the success of deep learning comes from high-dimensional representations. Deep learning has already demonstrated that complex, uninterpretable systems can surpass human-designed control methods. The high dimensional actuation of the disclosed system may be the missing piece to unlocking the full potential of machine learning and deep learning techniques for robotic control.

The robotic manipulator systems disclosed herein may provide several technical advantages over conventional robotic systems, which lack the dexterity necessary to perform complex tasks. For example, conventional robotic hands have at best 16-24 degrees of freedom due to having fewer actuators. These conventional systems are unable to scale up the number of individually actuated tendons (and therefore unable to increase degrees of freedom) due to inherent constraints in conventional robotic design. For example, conventional robotic systems are unable to add more actuators due to space limitations caused by locating actuators near the end-effectors (e.g., locating motors in tight spaces like the finger or wrist of conventional robots). The disclosed robotic manipulator systems may overcome this limitation by separating the actuator grids from the robotic appendages such that they are connected only through the plurality of tendons, allowing greater space to accommodate a large number of actuators (e.g., 30 or more, 35 or more, 40 or more, 50 or more, 60 or more, 100 or more, 200 or more, 300 or more, 900 or more, 1000 or more) for controlling a large number of tendons (e.g., 30 or more, 35 or more, 40 or more, 50 or more, 60 or more, 100 or more, 200 or more, 300 or more, 900 or more, 1000 or more) per robotic appendage. Separating the actuators from the robotic appendages may allow unprecedented scalability in degrees of freedom (e.g., 30 or more, 35 or more, 40 or more, 50 or more, 60 or more, 100 or more, 200 or more, 300 or more, 900 or more, 1000 or more, 2000 or more, or 3000 or more), while allowing for compact, lightweight, and/or mechanically robust designs. Furthermore, the modularity of the actuators and tendons may support varied tendon routing configurations, which may unlock new motion primitives not feasible with conventional designs.

Further, the disclosed robotic manipulator systems can be superior to conventional robotic systems because the disclosed systems may not be limited by strict adherence to human morphology. For example, conventional robotic systems are designed to mimic human bodies or hands, which necessarily constrains dexterity to that possessed by human morphology. In contrast, the disclosed robotic manipulator systems may not be constrained by human morphology, allowing increased dexterity compared to human bodies or hands. A single robotic appendage of the disclosed system can be manipulated with a large number of degrees of freedom (e.g., 30 or more, 35 or more, 40 or more, 50 or more, 60 or more, 100 or more, 200 or more, 300 or more, 900 or more, 1000 or more), which may be greater than a human finger or a conventional robot that mimics a human hand.

The disclosed robotic manipulator systems may also be superior because they may be highly robust compared to conventional robotic systems. For example, failure of an actuator in a conventional robotic system can cause the whole robotic system to become inoperable until the actuator is replaced or repaired. In contrast, due to the high volume of actuators and tendons, the disclosed robotic manipulator systems may be highly fault tolerant and can remain operational despite failure of actuators or tendons. For example, each appendage of the disclosed robotic manipulator systems may remain operational despite failure of up to 40% of individually actuated tendons.

By incorporating a large number of individually actuated tendons (e.g., 30 or more, 35 or more, 40 or more, 50 or more, 60 or more, 100 or more, 200 or more, 300 or more, 900 or more, 1000 or more) per robotic appendage, the disclosed robotic manipulator systems can also move more smoothly compared to conventional robotic systems. For example, due to having only 16-24 degrees of freedom, conventional robotic systems make jerky motions, which can be compounded by backlash from electric motors or pneumatic systems. This can be highly detrimental in tasks that require extreme precision, such as robotic surgery or manufacturing wire harnesses. In contrast, the high dimensional actuation of the disclosed systems can enable smooth, continuous motion, which can be advantageous for tasks requiring high precision. For example, the disclosed systems may have smoother, more organic motion by mimicking the redundancy of biological muscle structures.

Beyond hardware, the disclosed robotic manipulator systems may be a foundational platform for developing next-generation control methods, including model-based optimization and reinforcement learning (RL) techniques. The unprecedented number of actuators (e.g., 30 or more, 35 or more, 40 or more, 50 or more, 60 or more, 100 or more, 200 or more, 300 or more, 900 or more, 1000 or more, 2000 or more, or 3000 or more) per robotic appendage and unprecedented number of sensors (e.g., 30 or more, 35 or more, 40 or more, 50 or more, 60 or more, 100 or more, 200 or more, 300 or more, 900 or more, 1000 or more, 2000 or more, or 3000 or more) per robotic appendage in the disclosed systems may enable high-dimensional policy learning, which can allow control algorithms to leverage redundancy for robustness, adaptability, and emergent behaviors. Traditional robotic platforms are constrained by low degrees of freedom and simplistic kinematic structures, which limit the complexity of learnable policies. In contrast, the disclosed robotic manipulator system's high-dimensional actuation space may allow for rich contact interactions, nuanced force control, and emergent dexterous behaviors that mirror biological motion. The disclosed systems may be an ideal testbed for data-driven control, including physics-informed RL, imitation learning, and/or differentiable physics-based optimization. Because advances in robotic software and artificial intelligence (AI) may depend on corresponding advances in hardware, the disclosed systems can represent a significant step forward by providing mechanical infrastructure to accelerate breakthroughs in AI-driven dexterous manipulation. By fundamentally decoupling mechanical constraints from actuation complexity, the disclosed system can set a new standard for high-dimensional robotics, and may surpass existing state-of-the-art solutions in scalability, reliability, and versatility.

While reference is made to robotic appendages comprising large numbers of individually actuated tendons, it should be understood that the robotic manipulator systems disclosed herein can comprise fewer individually actuated tendons per robotic appendage if a given task does not require large degrees of freedom. For example, the robotic manipulator system can comprise 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, 30 or more, 31 or more, 32 or more, 33 or more, or 34 or more actuators for individually actuating 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, 30 or more, 31 or more, 32 or more, 33 or more, or 34 or more tendons per robotic appendage.

In some embodiments, an exemplary robotic manipulator system comprises: a robotic appendage comprising: a support structure, a series of discs arranged along a longitudinal axis of the support structure, and a plurality of tendons extending through the series of discs, wherein a distal end of each tendon of the plurality of tendons is attached to the series of discs; and an actuator grid comprising an arrangement of 35 or more actuators, each actuator of the 35 or more actuators engaging one or more proximal ends of one or more tendons of the plurality of tendons. In some embodiments, the actuator grid comprises less than 900 actuators. In some embodiments, the actuator grid is connected to the robotic appendage only through the plurality of tendons. In some embodiments, the actuator grid comprises 35 or more slots for accommodating the 35 or more actuators. In some embodiments, the actuator grid comprises a honeycomb shape. In some embodiments, each actuator of the 35 or more actuators is removable from the actuator grid.

In some embodiments, the robotic manipulator system further comprises one or more tubes positioned in between the robotic appendage and the actuator grid, wherein each tube is configured to gather one or more tendons of the plurality of tendons. In some embodiments, at least one tube of the one or more tubes comprises a lubricated interior surface configured to reduce frictional force between the gathered one or more tendons or between the gathered one or more tendons and the lubricated interior surface of the at least one tube. In some embodiments, at least one tube of the one or more tubes gathers one or more tendons configured to produce frictional force between the gathered one or more tendons or between the gathered one or more tendons and an interior surface of the at least one tube during actuation of the gathered one or more tendons. In some embodiments, the robotic manipulator system further comprises a pulley system positioned in between the robotic appendage and the actuator grid, wherein the pulley system engages the plurality of tendons such that each tendon is separated from other tendons in the plurality of tendons.

In some embodiments, the actuator grid comprises a concave surface. In some embodiments, the robotic appendage further comprises a sleeve disposed around the series of discs and the support structure. In some embodiments, the series of discs comprises a first disc and a second disc, wherein the first disc and the second disc are different in shape, size, width, depth, height, material, or concavity, or any combination thereof. In some embodiments, at least one tendon of the plurality of tendons extends through the series of discs in a helical manner.

In some embodiments, the actuator grid comprises at least one actuator control unit configured to generate a plurality of actuation signals for each actuator of the 35 or more actuators, wherein each actuator is configured to actuate one or more tendons based on a received actuation signal of the plurality of actuation signals. In some embodiments, the at least one control unit is configured to generate the plurality of actuation signals based on a control signal received from a machine learning model configured to generate the control signal based on a determination of which tendons of the plurality of tendons to actuate to execute a given task. In some embodiments, the given task is chicken deboning, wire harness manufacturing, taping, removing tape, or fabric manufacturing.

In some embodiments, at least one actuator of the 35 or more actuators comprises: a capstan securing a proximal end of one or more tendons of the plurality of tendons; and a motor coupled to the capstan, wherein the motor is configured to rotate the capstan to decrease or increase tension of the one or more tendons. In some embodiments, each disc of the series of discs comprises a plurality of routing apertures for receiving one or more tendons of the plurality of tendons.

In some embodiments, the actuator grid is a first actuator grid, and the 35 or more actuators are a first 35 or more actuators, the system further comprising a second actuator grid configured to house a second 35 or more of actuators. In some embodiments, the robotic appendage is a first robotic appendage comprising a first plurality of tendons, the system further comprising a second robotic appendage comprising a second plurality of tendons. In some embodiments, each actuator of the second 35 or more actuators engages one or more proximal ends of one or more tendons of the first plurality of tendons of the first robotic appendage or the second plurality of tendons of the second robotic appendage. In some embodiments, one or more actuators of the first 35 or more actuators engage one or more proximal ends of one or more tendons of the second plurality of tendons of the second robotic appendage.

In some embodiments, the robotic manipulator system further comprises a base at a proximal end of the first robotic appendage or a proximal end of the second robotic appendage or both. In some embodiments, the robotic manipulator system further comprises an arm supporting the base. In some embodiments, the robotic manipulator system further comprises a guide plate comprising a plurality of apertures for receiving the plurality of tendons, wherein the guide plate is configured to guide the plurality of tendons from the actuator grid to the robotic appendage. In some embodiments, the robotic manipulator system further comprises a plurality of metallic sleeves, wherein each metallic sleeve of the plurality of metallic sleeves is installed over at least a portion of a tendon of the plurality of tendons.

### BRIEF DESCRIPTION OF THE DRAWINGS

For a better understanding of the various described embodiments, reference should be made to the Detailed Description of the Invention below, in conjunction with the following drawings in which like reference numerals refer to corresponding parts throughout the figures.

FIG. 1 illustrates a perspective view of one embodiment of a robotic manipulator system, according to some embodiments.

FIG. 2 illustrates a perspective view of an exemplary robotic appendage, according to some embodiments.

FIG. 3A illustrates a perspective view of an exemplary robotic appendage having a tendon routed in a parallel manner, according to some embodiments.

FIG. 3B illustrates a perspective view of an exemplary robotic appendage having a tendon routed in a helical manner, according to some embodiments.

FIG. 3C illustrates a perspective view of an exemplary robotic appendage having tendons routed in a helical manner, according to some embodiments.

FIG. 4 illustrates an exemplary gripper comprising more than one robotic appendages.

FIG. 5A illustrates a perspective view of an exemplary actuator, according to some embodiments.

FIG. 5B illustrates a top view of an exemplary actuator, according to some embodiments.

FIG. 6 illustrates a perspective view of an exemplary actuator grid housing a plurality of actuators, according to some embodiments.

FIG. 7 illustrates an exemplary pulley system, according to some embodiments.

FIG. 8A illustrates a perspective view of an exemplary shooter assembly, according to some embodiments.

FIG. 8B illustrates a side view of an exemplary shooter assembly, according to some embodiments.

FIG. 9 illustrates a perspective view of an exemplary array of shooter assemblies, according to some embodiments.

FIG. 10A illustrates a perspective view of another exemplary robotic manipulator system having an arm supporting an exemplary gripper, according to some embodiments.

FIG. 10B illustrates a top view of the exemplary robotic manipulator system of FIG. 10A, according to some embodiments.

FIG. 11A illustrates a perspective view of another exemplary robotic manipulator system having two exemplary grippers, with each supported by an arm, according to some embodiments.

FIG. 11B illustrates a top view of the exemplary robotic manipulator system, of FIG. 11A according to some embodiments.

FIG. 12 illustrates an exemplary computing device, according to some embodiments.

FIG. 13A illustrates a perspective view of an exemplary robotic appendage comprising a series of joints, according to some embodiments.

FIG. 13B illustrates a side view of an exemplary robotic appendage comprising a series of joints, according to some embodiments.

FIG. 14A illustrates two exemplary lumen tubes, according to some embodiments.

FIG. 14B illustrates an exemplary branching lumen tube, according to some embodiments.

FIG. 14C illustrates an exemplary branching lumen tube guiding a plurality of tendons into an exemplary gripper, according to some embodiments.

FIG. 14D illustrates exemplary metallic sleeves installed on tendons, according to some embodiments.

FIG. 15A illustrates an exemplary robotic system comprising a guide plate, according to some embodiments.

FIG. 15B illustrates a top view of the guide plate of FIG. 15A, according to some embodiments.

FIG. 16 illustrates an exemplary robotic system comprising a pneumatic or hydraulic system, according to some embodiments.

FIG. 17A illustrates an exemplary robotic system comprising another exemplary gripper and hexagonal actuator grids, according to some embodiments.

FIG. 17B illustrates a top view of the robotic system of FIG. 17A, according to some embodiments.

### DETAILED DESCRIPTION OF THE PRESENT INVENTIVE CONCEPT

The present disclosure is directed to a robotic manipulator system. The described robotic manipulator system can be used to perform tasks that require high levels of dexterity that typically require human labor or are even beyond the capability of typical robotic systems and human labor. For example, the described robotic manipulator system can be used to debone chicken, to manufacture wire harnesses, to tape or remove tape, or to assist in robotic surgery.

In some embodiments, the robotic manipulator system can include at least one robotic appendage that includes a support structure, a series of discs arranged along a longitudinal axis of the support structure, and 35 or more tendons (e.g., 30 or more, 35 or more, 40 or more, 50 or more, 60 or more, 100 or more, 200 or more, 300 or more, 900 or more, 1000 or more) extending through the series of discs with distal ends attached to discs of the series of discs. The system can also include at least one actuator grid comprising an arrangement of 35 or more actuators (e.g., 30 or more, 35 or more, 40 or more, 50 or more, 60 or more, 100 or more, 200 or more, 300 or more, 900 or more, 1000 or more), where each actuator engages the proximal ends of the plurality of tendons. The actuator grid can be separate from the robotic appendage and connected only through the plurality of tendons, such that there may be space for a large number of actuators to individually actuate the tendons, achieving a large degrees of freedom (e.g., 30 or more, 35 or more, 40 or more, 50 or more, 60 or more, 100 or more, 200 or more, 300 or more, 900 or more, 1000 or more) for each robotic appendage. When the tendons are actuated, tension in the tendons can cause the robotic appendage to move in desired directions. The robotic manipulator system can be highly modular and may comprise any number of actuator grids (e.g., 1 or more, 2 or more, 3 or more, 4 or more, 5 or more, 10 or more, 15 or more, 20 or more, 50 or more), any number of actuators (e.g., 30 or more, 35 or more, 40 or more, 50 or more, 60 or more, 100 or more, 200 or more, 300 or more, 900 or more, 1000 or more) per robotic appendage, or any number of robotic appendages (e.g., 1 or more, 2 or more, 3 or more, 4 or more, 5 or more, 10 or more, 15 or more, 20 or more, 50 or more) arranged to fit a given task, and may achieve a high number of degrees of freedom (e.g., 30 or more, 35 or more, 40 or more, 50 or more, 60 or more, 100 or more, 200 or more, 300 or more, 900 or more, 1000 or more) per robotic appendage. For example, the actuator grid may be configured such that actuators can be removed or replaced as desired.

As discussed above, while the disclosed systems can incorporate a large number of individually actuated tendons due to reduced space constraints enabled by the separation of actuators and robotic appendages, in some embodiments, design limitations (e.g., space constraints in the environment or space constraints due to a given task) may limit the number of individually actuated tendons (e.g., less than 1000, less than 900, less than 800, less than 700, less than 600, less than 300, less than 200, less than 100, less than 60, less than 50, or less than 40) per robotic appendage, the number of actuators (e.g., less than 1000, less than 900, less than 800, less than 700, less than 600, less than 300, less than 200, less than 100, less than 60, less than 50, or less than 40) per robotic appendage, the number of discs (e.g., 50 or less, 40 or less, 30 or less, 20 or less, 15 or less, 10 or less, 9 or less, 8 or less, 7 or less, 6 or less, 5 or less, 4 or less, 3 or less) per robotic appendage, the number of actuator grids (e.g., 50 or less, 40 or less, 30 or less, 20 or less, 15 or less, 10 or less, 9 or less, 8 or less, 7 or less, 6 or less, 5 or less, 4 or less, 3 or less) and/or the number of robotic appendages (e.g., 50 or less, 40 or less, 30 or less, 20 or less, 15 or less, 10 or less, 9 or less, 8 or less, 7 or less, 6 or less, 5 or less, 4 or less, 3 or less). In some embodiments, this may limit the number of degrees of freedom (e.g., less than 1000, less than 900, less than 800, less than 700, less than 600, less than 300, less than 200, less than 100, less than 60, less than 50, or less than 40) per robotic appendage.

While reference is made to robotic appendages comprising large numbers of individually actuated tendons, it should be understood that the robotic manipulator systems disclosed herein can comprise fewer individually actuated tendons per robotic appendage if a given task does not require large degrees of freedom. For example, the robotic manipulator system can comprise 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, 30 or more, 31 or more, 32 or more, 33 or more, or 34 or more actuators for individually actuating 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, 30 or more, 31 or more, 32 or more, 33 or more, or 34 or more tendons per robotic appendage.

In one exemplary embodiment, the robotic manipulator system can include more than one robotic appendage (e.g., 2 or more, 3 or more, 4 or more, 5 or more, 10 or more, 15 or more, 20 or more, 50 or more, or 100 or more) coupled at the proximal ends of the robotic appendages to form a gripper or an end-effector. In some embodiments, design limitations (e.g., space constraints in the environment or space constraints due to a given task) may limit the number of robotic appendages (e.g., 100 or less, 50 or less, 40 or less, 30 or less, 20 or less, 15 or less, 10 or less, 9 or less, 8 or less, 7 or less, 6 or less, 5 or less, 4 or less, 3 or less) per gripper. For example, a gripper can comprise 2 to 100 robotic appendages, 3 to 10 robotic appendages, 10 to 25 robotic appendages, or 5 to 30 robotic appendages. In another exemplary embodiment, a gripper can be supported by an arm configured to position the gripper in desired locations. In another exemplary embodiment, the robotic manipulator system can include two or more grippers (e.g., 2 or more, 3 or more, 4 or more, 5 or more, 10 or more, 15 or more, 20 or more, 50 or more), with each gripper being supported by an arm. In some embodiments, design limitations (e.g., space constraints in the environment or space constraints due to a given task) may limit the number of grippers (e.g., 50 or less, 40 or less, 30 or less, 20 or less, 15 or less, 10 or less, 9 or less, 8 or less, 7 or less, 6 or less, 5 or less, 4 or less, 3 or less). For example, a robotic manipulator system can comprise 1 to 50 robotic grippers, 1 to 20 robotic grippers, 1 to 15 robotic grippers, or 1 to 10 robotic grippers. In another exemplary embodiment, the robotic manipulator system can be highly redundant, such that failure of any given tendon or actuator does not render the robotic manipulator system inoperable.

The disclosed robotic manipulator systems can be used for a variety of tasks in a variety of fields. In some embodiments, the highly dexterous robotic manipulator system can be used as a surgical robot. For example, the robotic manipulator systems can be used to perform minimally invasive surgeries. The disclosed highly dexterous robotic manipulator systems may be well-suited to performing minimally invasive surgeries because it may be able to perform precise movements, allowing for complex maneuvers in tight spaces that human hands or conventional robots may struggle with. For example, the disclosed highly dexterous robotic manipulator systems may be used to operate miniature endoscopic tools with high precision. In some embodiments, the robotic manipulator systems can be used for manufacturing and assembly. For example, the disclosed highly dexterous robotic manipulator systems may be well suited to assembling intricate components (e.g., for electronics or automotives industries), where precision and flexibility are desirous for handling small parts. In some embodiments, the disclosed robotic manipulator systems may be well suited for robotic prosthetics. For example, the ability of the disclosed system to precisely manipulate biological soft tissues may enable naturalistic movements and good integration with a human body and soft tissues. In some embodiments, the disclosed systems may be used as or integrated into wearable exoskeletons or other forms of human augmentation. In some embodiments, the highly dexterous robotic manipulator system can be used for research and exploration. For example, the disclosed systems can be used in hazardous environments (e.g., underwater or in space) and may perform tasks that require delicate handling (e.g., repairing satellites or other objects in zero-gravity). In some embodiments, the disclosed systems can be integrated with haptic feedback systems in virtual reality (VR) or augmented reality (AR) systems. The disclosed highly dexterous robotic systems may be able to provide realistic tactile sensations that correspond to virtual objects and environments within the VR or AR systems, making virtual interactions feel more lifelike. The disclosed robotic manipulator systems are not limited to the above mentioned tasks or fields, and may be well-suited for uses in other fields, including, but not limited to, art and sculpture, food preparation, elderly care and assistance, telepresence and remote operations, education and training, or entertainment.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

Although the following description uses terms “first,” “second,” etc. to describe various elements, these elements should not be limited by the terms. These terms are only used to distinguish one element from another. For example, a first robotic appendage could be termed a second robotic appendage, and, similarly, a second robotic appendage could be termed a first robotic appendage, without departing from the scope of the various described embodiments.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

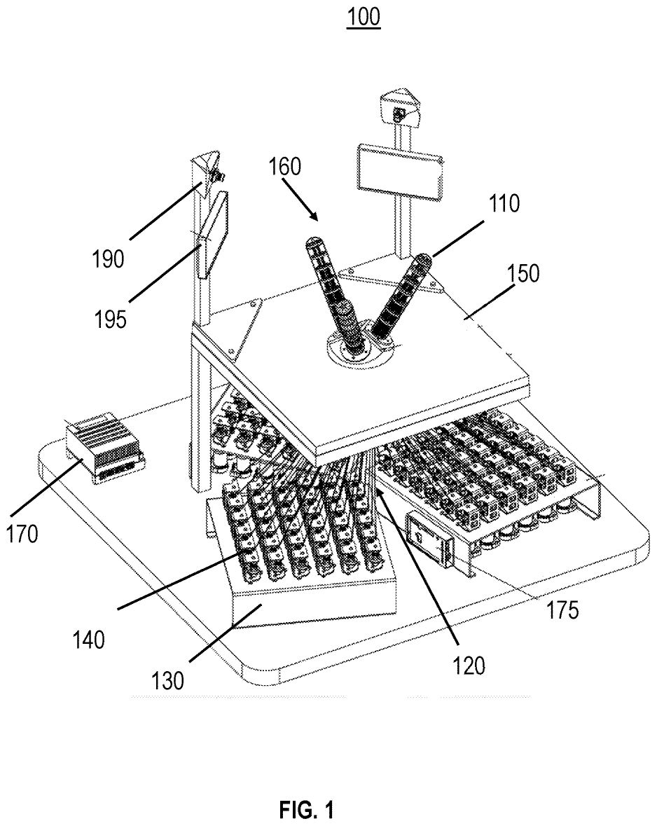

FIG. 1 illustrates an example robotic manipulator system 100. The example robotic manipulator system 100 can be used in any settings where highly dexterous manipulation may be desirable. For example, the robotic manipulator system 100 can be used to execute orientation tasks, for manufacturing (e.g., assembling intricate components), for quality control and testing (e.g., by applying load on objects to test for strengths and/or failure modes), for surgical tasks (e.g., minimally invasive surgery and/or operating miniature endoscopic tools), for robotic prosthetics, for human augmentation (e.g., wearable exoskeletons), research and exploration (e.g., in space or underwater), for virtual reality or augmented reality systems (e.g., to provide realistic tactile sensations and haptic feedback), for art and sculpture, food preparation, elderly care and assistance, telepresence and remote operations, education and training, or entertainment.

The robotic manipulator system can be mounted on a stationary surface (e.g., a workbench, a floor, or a combination thereof). In some embodiments, the robotic manipulator system can be mounted on a mobile platform (e.g., an autonomous vehicle or a cart). The robotic manipulator system 100 can include at least one robotic appendage 110, 35 or more tendons 120 extending through each robotic appendage 110, at least one actuator grid 130 comprising an arrangement of 35 or more actuators 140, and a computing system 170. Each actuator of the 35 or more actuators 140 can engage the proximal ends of a tendon of the 35 or more tendons 120. Actuation of one or more tendons 120 by one or more actuators 140 can cause the robotic appendage 110 to tilt, bend, or otherwise deform, as discussed in further detail below. Because robotic appendage 110 can comprise 35 or more tendons 120 that can be independently actuated by 35 or more actuators, robotic appendage 110 can have 35 or more degrees of freedom, achieving a higher level of dexterity than conventional robotic systems. In some embodiments, the robotic manipulator system 100 can have more than one robotic appendage 110 coupled together to form a gripper 160. In the depicted example, a gripper 160 comprising three robotic appendages 110 can have 105 or more degrees of freedom.

Conventional robotic systems achieve only 16-24 degrees of freedom, and are unable to support an increased actuators or tendons to achieve a higher level of dexterity due to space constraints of conventional robotic systems. The robotic manipulator system 100 described overcomes these limitations due to separation of the actuators 140 and actuator grids 130 from the robotic appendages 110. For example, separation of the actuator grids 130 and the actuators 140 from the robotic appendage 110 increases available space to house actuators 140, enabling highly scalable degrees of freedom for the robotic appendage. A robotic appendage comprising a large number of tendons 120 (e.g., 30 or more, 35 or more, 40 or more, 50 or more, 60 or more, 100 or more, 200 or more, 300 or more, 900 or more, 1000 or more, 2000 or more, or 3000 or more) individually controlled by a large number of actuators 140 (e.g., 30 or more, 35 or more, 40 or more, 50 or more, 60 or more, 100 or more, 200 or more, 300 or more, 900 or more, 1000 or more, 2000 or more, or 3000 or more) can have a large number of degrees of freedom (e.g., 30 or more, 35 or more, 40 or more, 50 or more, 60 or more, 100 or more, 200 or more, 300 or more, 900 or more, 1000 or more, 2000 or more, or 3000 or more). In some embodiments, separation of the actuator grid 130 and the plurality of actuators 140 from the robotic appendage 110 may allow robotic appendage 110 to remain compact, lightweight, and robust since the 35 or more actuators 140 are not embedded directly within robotic appendage 110.

As discussed above, while the disclosed systems can incorporate a large number of individually actuated tendons and/or actuators due to reduced space constraints enabled by the separation of actuators and robotic appendages, in some embodiments, design limitations (e.g., space constraints in the environment or space constraints due to a given task) may limit the number of individually actuated tendons (e.g. less than 1000, less than 900, less than 800, less than 700, less than 600, less than 300, less than 200, less than 100, less than 60, less than 50, or less than 40) per robotic appendage 110 and/or limit the number of actuators (e.g. less than 1000, less than 900, less than 800, less than 700, less than 600, less than 300, less than 200, less than 100, less than 60, less than 50, or less than 40) per robotic appendage 110. In some embodiments, this may limit the number of degrees of freedom (e.g., less than 1000, less than 900, less than 800, less than 700, less than 600, less than 300, less than 200, less than 100, less than 60, less than 50, or less than 40) per robotic appendage 110. In some embodiments, robotic manipulator system 100 may contain 35 to 40, 35 to 50, 35 to 60, 35 to 100, 35 to 200, 35 to 300, 35 to 600, 35 to 700, 35 to 800, 35 to 900, or 35 to 1000 tendons 120 and/or actuators 140 per robotic appendage 110, which may enable 35 to 40, 35 to 50, 35 to 60, 35 to 100, 35 to 200, 35 to 300, 35 to 600, 35 to 700, 35 to 800, 35 to 900, or 35 to 1000 degrees of freedom per robotic appendage 110.

In some embodiments, the actuator grids 130 can be connected to the robotic appendages 110 only through the plurality of tendons 120. For example, robotic appendage 110 may be mounted on a workbench 150 and the at least one actuator grid 130 may be located on a different surface below the workbench 150. As shown in FIG. 1, one or more actuator grids 130 can be arranged horizontally on a surface such that tendons 120 extend upwards from the one or more actuator grids 130. The gripper 106 comprising one or more robotic appendages 110 can be mounted on a workbench 150 suspended above the actuator grids 130. The computing system 170 may be on the surface with the actuator grids or on the workbench 150.

Robotic manipulator system 100 can include redundant features (e.g., redundant actuators 140 and redundant tendons 120). For example, each robotic appendage 110 of robotic manipulator system 100 can include 35 or more tendons 120, 45 or more tendons 120, 55 or more tendons 120, 65 or more tendons 120, 75 or more tendons 120, 85 or more tendons 120, 95 or more tendons 120, 100 or more tendons 120, 125 or more tendons 120, 150 or more tendons 120, 175 or more tendons 120, 200 or more tendons 120, 225 or more tendons 120, 250 or more tendons 120, 275 or more tendons 120, 300 or more tendons 120, 325 or more tendons 120, 350 or more tendons 120, 375 or more tendons 120, 400 or more tendons 120, 425 or more tendons 120, 450 or more tendons 120, 475 or more tendons 120, 500 or more tendons 120, 525 or more tendons 120, 550 or more tendons 120, 575 or more tendons 120, 600 or more tendons 120, 625 or more tendons 120, 650 or more tendons 120, 675 or more tendons 120, 700 or more tendons 120, 725 or more tendons 120, 750 or more tendons 120, 775 or more tendons 120, 800 or more tendons 120, 825 or more tendons 120, 850 or more tendons 120, 875 or more tendons 120, 900 or more tendons 120, 925 or more tendons 120, 950 or more tendons 120, 975 or more tendons 120, or 1000 or more tendons 120.

For example, each robotic appendage 110 of robotic manipulator system 100 can include 35 or more actuators 140, 45 or more actuators 140, 55 or more actuators 140, 65 or more actuators 140, 75 or more actuators 140, 85 or more actuators 140, 95 or more actuators 140, 100 or more actuators 140, 125 or more actuators 140, 150 or more actuators 140, 175 or more actuators 140, 200 or more actuators 140, 225 or more actuators 140, 250 or more actuators 140, 275 or more actuators 140, 300 or more actuators 140, 325 or more actuators 140, 350 or more actuators 140, 375 or more actuators 140, 400 or more actuators 140, 425 or more actuators 140, 450 or more actuators 140, 475 or more actuators 140, 500 or more actuators 140, 525 or more actuators 140, 550 or more actuators 140, 575 or more actuators 140, 600 or more actuators 140, 625 or more actuators 140, 650 or more actuators 140, 675 or more actuators 140, 700 or more actuators 140, 725 or more actuators 140, 750 or more actuators 140, 775 or more actuators 140, 800 or more actuators 140, 825 or more actuators 140, 850 or more actuators 140, 875 or more actuators 140, 900 or more actuators 140, 925 or more actuators 140, 950 or more actuators 140, 975 or more actuators 140, or 1000 or more actuators 140.

As discussed above, while the disclosed systems can incorporate a large number of individually actuated tendons due to reduced space constraints enabled by the separation of actuators and robotic appendages, in some embodiments, design limitations (e.g., space constraints in the environment or space constraints due to a given task) may limit the number of individually actuated tendons. For example, each robotic appendage 110 of robotic manipulator system 100 can include 1000 or less tendons 120, 975or less tendons 120, 950 or less tendons 120, 925 or less tendons 120, 900 or less tendons 120, 875 or less tendons 120, 850 or less tendons 120, 825 or less tendons 120, 800 or less tendons 120, 775 or less tendons 120, 750 or less tendons 120, 725 or less tendons 120, 700 or less tendons 120, 675 or less tendons 120, 650 or less tendons 120, 625 or less tendons 120, 600 or less tendons 120, 575 or less tendons 120, 550 or less tendons 120, 525 or less tendons 120, 500 or less tendons 120, 475 or less tendons 120, 450 or less tendons 120, 425 or less tendons 120, 400 or less tendons 120, 375 or less tendons 120, 350 or less tendons 120, 325 or less tendons 120, 300 or less tendons 120, 275 or less tendons 120, 250 or less tendons 120, 225 or less tendons 120, 200 or less tendons 120, 175 or less tendons 120, 150 or less tendons 120, 125 or less tendons 120, 100 or less tendons 120, 95 or less tendons 120, 85 or less tendons 120, 75 or less tendons 120, 65 or less tendons 120, 55 or less tendons 120, 45 or less tendons 120, or 40 or less tendons 120.

As discussed above, while the disclosed systems can incorporate a large number of individually actuated tendons due to reduced space constraints enabled by the separation of actuators and robotic appendages, in some embodiments, design limitations (e.g., space constraints in the environment or space constraints due to a given task) may limit the number of actuators. For example, each robotic appendage 110 of robotic manipulator system 100 can include 1000 or less actuators 140, 975 or less actuators 140, 950 or less actuators 140, 925 or less actuators 140, 900 or less actuators 140, 875 or less actuators 140, 850 or less actuators 140, 825 or less actuators 140, 800 or less actuators 140, 775 or less actuators 140, 750 or less actuators 140, 725 or less actuators 140, 700 or less actuators 140, 675 or less actuators 140, 650 or less actuators 140, 625 or less actuators 140, 600 or less actuators 140, 575 or less actuators 140, 550 or less actuators 140, 525 or less actuators 140, 500 or less actuators 140, 475 or less actuators 140, 450 or less actuators 140, 425 or less actuators 140, 400 or less actuators 140, 375 or less actuators 140, 350 or less actuators 140, 325 or less actuators 140, 300 or less actuators 140, 275 or less actuators 140, 250 or less actuators 140, 225 or less actuators 140, 200 or less actuators 140, 175 or less actuators 140, 150 or less actuators 140, 125 or less actuators 140, 100 or less actuators 140, 95 or less actuators 140, 85 or less actuators 140, 75 or less actuators 140, 65 or less actuators 140, 55 or less actuators 140, 45 or less actuators 140, or 40 or less actuators 140.

In some embodiments, the redundancy of the tendons 120 and actuators 140 can allow for smooth movement and robustness of robotic manipulator system 100. In some embodiments, the redundancy of the tendons 120 and/or actuators 140 can allow robotic manipulator system to remain fully operational without needing maintenance, despite failure of any given tendon 120 or actuator 140. For example, if one or more tendons 120 or one or more actuators 140 fail, other tendons 120 or actuators 140 can compensate for the failure. In some embodiments, robotic manipulator system 100 can still remain operational without requiring maintenance when up to about 10%, up to about 20%, up to about 30% or up to about 40% of tendons fail. In some embodiments, robotic manipulator system 100 can still remain operational without requiring maintenance when up to about 10%, up to about 20%, up to about 30%, or up to about 40% of actuators fail. In some embodiments, computing system 170 can detect in real-time whether a tendon 120 or actuator 140 has failed using one or more sensors, and can control other tendons 120 or actuators 140 to compensate for the failure. For example, computing system 170 may redistribute tasks to tendons 120 adjacent to the failed tendon 120, or to actuators 140 adjacent to the failed actuator 140.

Optionally, the plurality of tendons 120 of robotic manipulator system 100 may comprise groups of multiple redundant tendons 120 such that each group of multiple redundant tendons 120 are configured to perform the same or similar function. If one tendon in the group of multiple redundant tendons 120 malfunctions or breaks, the other tendons in the group of multiple redundant tendons 120 configured to perform the same or similar function can compensate, allowing the robotic manipulator system to remain operational despite the malfunctioning tendon. Optionally, the plurality of actuators of robotic manipulator system 100 may comprise groups of multiple redundant actuators 140 such that each group of multiple redundant actuators 140 are configured to perform the same or similar function. If one actuator 140 in the group of multiple redundant actuators 140 malfunctions, the other actuators configured to perform the same or similar function can compensate, allowing the robotic manipulator system to remain operational despite the malfunctioning actuator 140.

In some embodiments, the redundancy of the tendons 120 and/or actuators 140 can allow for easy and inexpensive maintenance of robotic manipulator system 100. For example, since robotic manipulator system 100 can still function normally despite malfunctioning or broken tendons 120 or actuators 140, maintenance may not be needed every time a tendon 120 or actuator 140 fails.

In some embodiments, the arrangement of actuators 140 have a parallel configuration such that each actuator 140 can function independently of other actuators 140. The parallel configuration of the arrangement of actuators 140 can enable robotic appendage 110 to be more robust and fault tolerant than conventional robotic systems with series-configured actuators, where failure of one actuator in a conventional system may cause failure of the whole system.

The plurality of tendons 120 can include ropes, strings, or cables. In some embodiments, a tendon 120 can be made of carbon fibers or carbon nano tubes. In some embodiments, a tendon 120 can be made of a non-rigid material (e.g., ropes or strings). In some embodiments, a tendon 120 can be made of semi-rigid materials (e.g., steel wire, aircraft cables, other composite materials), which can enable both tension and compression in the tendon 120. In some embodiments, a tendon 120 can comprise one or more regions comprising fully rigid materials, while at least a portion of the distal and proximal ends comprise non-rigid or semi-rigid materials. In some embodiments, a tendon 120 can be made of non-rigid or semi-rigid materials while at a metallic sleeve (discussed in more detail below) can be installed over at least a portion of the tendon 120 to provide rigidity. In some embodiments, a tendon 120 may comprise elastic materials (e.g., rubber or elastomeric polymers). For example, a tendon 120 may comprise a dielectric elastomer. In some embodiments, a tendon 120 may be deformable. For example, a tendon 120 may comprise shape memory alloys, dielectric elastomers, or piezoelectric polymers.

In some embodiments, each actuator grid 130 may comprise an actuator control unit 175 configured to control actuation of the tendons 120 by generating a plurality of actuation signals for each actuator 140. The actuator control unit 175 can generate the plurality of actuation signals based on a control signal received from computing system 170. Computing system 170 may be communicatively coupled to the at least one actuator control unit 175 by wires. In some embodiments, computing system 170 may be configured to communicate with the actuator control unit 175 wirelessly (e.g., via Bluetooth, Wi-Fi, infrared signals, or other wireless communication methods). Computing system 170 may generate the control signal based on a determination of which tendons of the plurality of tendons to actuate in order to execute a given task (e.g., chicken deboning, surgical procedures, etc.). Computing system 170 may comprise a machine learning model or a deep learning model trained to generate control signals based on a given task and feedback from sensor systems.

Robotic manipulator system 100 may be well-suited for control by a machine learning or deep learning model because robotic manipulator system 100 has a high number of degrees of freedom (e.g., 30 or more, 35 or more, 40 or more, 50 or more, 60 or more, 100 or more, 200 or more, 300 or more, 900 or more, 1000 or more) for each robotic appendage 100. Due to having a high number of degrees of freedom, robotic manipulator system 100 can make complex and dynamic movements, which can be effectively learned and optimized through data-driven approaches. A machine learning, deep learning, or artificial intelligence model can analyze vast amounts of data from sensors and cameras of the robotic manipulator system 100, and adaptively refine the actions of the robotic manipulator system 100. The use of machine learning, deep learning, or artificial intelligence models may enable robotic manipulator system 100 to perform intricate tasks with precision, improve performance over time, and autonomously navigate unpredictable situations.

Robotic manipulator system 100 may comprise a plurality of sensors and/or one or more cameras 190 configured to provide feedback to computing system 170. For example, robotic manipulator system 100 may comprise one or more cameras 190 configured to take images or videos of components of robotic manipulator system 100 (e.g., robotic appendage 110, gripper 160) and send the images or videos to computing system 170. The one or more cameras 190 can be mounted to supports extending from the workbench 150 where the one or more robotic appendages 110 or gripper 160, as shown in FIG. 1. In some embodiments, the one or more cameras 190 can be mounted to supports extending from the surface underneath the workbench 150 where the one or more actuator grids 130 are arranged. Robotic manipulator system can include one or more light sources 195 configured to provide illumination for the one or more cameras 190. The one or more light sources 195 can be mounted to the same supports that the cameras 190 are mounted to.

In some embodiments, robotic manipulator system 100 may comprise a plurality of sensors positioned on tendons 120, actuators 140, or actuator grids 130 configured to sense information about the tendons 120, actuators 140, or actuator grid 130. The plurality of sensors may comprise strain sensors, torque sensors, current sensors, temperatures sensors, position sensors, or force sensors, or a combination thereof. The plurality of sensors may transmit sensor data to actuator control units 175 on the one or more actuator grids 130, which may process the sensor data and transmit the processed sensor data to computing system 170. In some embodiments, robotic manipulator system 100 may comprise a large number of sensors (e.g., 30 or more, 35 or more, 40 or more, 50 or more, 60 or more, 100 or more, 200 or more, 300 or more, 900 or more, 1000 or more, 2000 or more, or 3000 or more). In some embodiments, design limitations (e.g., space constraints in the environment or space constraints due to a given task) may limit the number of sensors (e.g. less than 3000, less than 2000, less than 1000, less than 900, less than 800, less than 700, less than 600, less than 300, less than 200, less than 100, less than 60, less than 50, or less than 40).

Computing system 170 can analyze the data from the sensors and the cameras 190, and generate control commands for actuators 140 based on the data from the sensors and cameras 190. Using the camera and sensor data as feedback can allow computing system 170 to control each tendon 120 with precision.

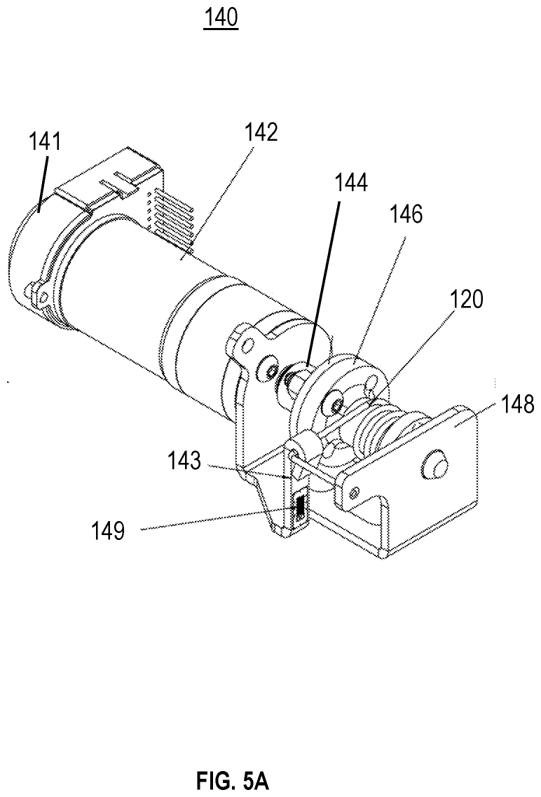

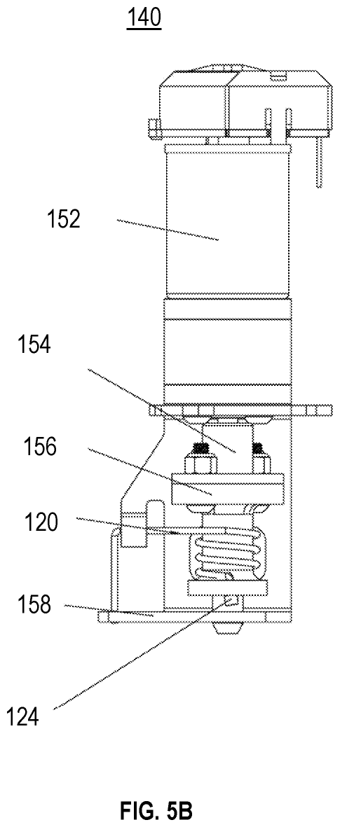

Robotic manipulator system 100 may comprise one or more tension sensors for each tendon 120 to monitor the tension of each tendon 120. In some embodiments, tension sensors may be integrated into the actuators 140, as discussed in more detail below with respect to FIGS. 5A and 5B. In some embodiments, tension sensors can be installed at any position along a tendon 120. For example, tension sensors can be installed on a tendon 120 at a position proximal to robotic appendage 110. Tension sensors installed on tendons 120 at positions proximal to robotic appendage 110 can more accurately measure the tension of tendons in the robotic appendage 110 than tension sensors installed on tendons 120 at positions far from robotic appendage 110. The tension sensors can be communicatively coupled to an actuator control unit 175, which can transmit received tension data to computing system 170. In some embodiments, the tension sensors can be compact. For example, the tension sensors may be as small as about 1 mm by about 5 mm by about 5 mm. In some embodiments, a tension sensor may comprise a strain gauge (e.g., a piezoelectric strain gauge).

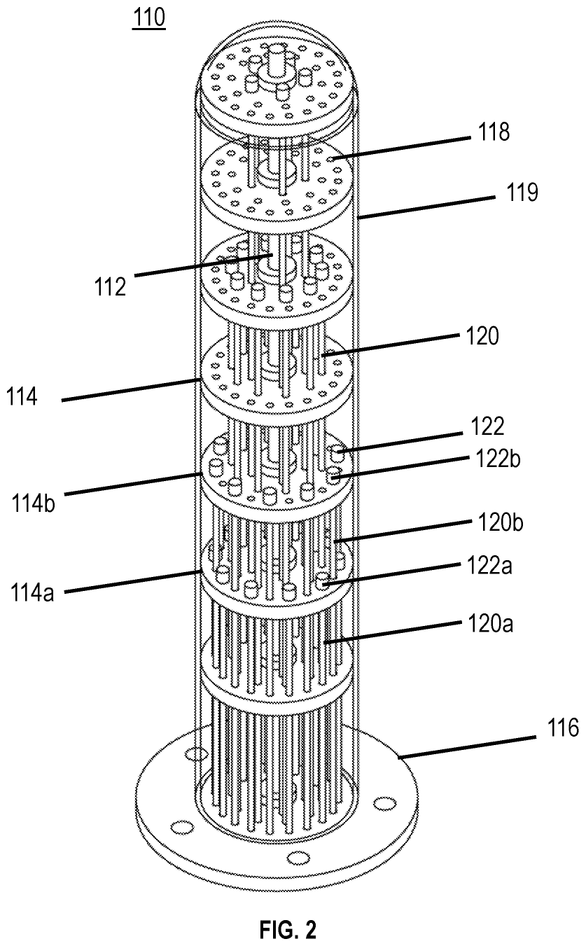

FIG. 2 shows a perspective view of an exemplary robotic appendage 110. In an exemplary embodiment, robotic appendage 110 comprises a support structure 112, a series of discs 114 arranged along a longitudinal axis of the support structure 112, and a plurality of tendons 120 extending through the series of discs 114.

Support structure 112 can comprise a rod shape. In some embodiments, support structure 112 can provide rigidity and/or support for the robotic appendage 110. Support structure 112 can be made of a semi-flexible material. For example, support structure 112 can be made of shape-memory alloys, plastics, composite materials, metals, or braided wires. In some embodiments, the material and corresponding degree of flexibility of support structure 112 may be selected based on a given task. For example, if the intended task may be better executed by a soft robotics system (e.g., assembly of delicate electronic components), the support structure 112 may be made of a more flexible material than if the intended task may be better handled by a hard robotics system (e.g., chicken deboning or removing tape). In some examples, the support structure 112 can comprise variable stiffness along the length. For example, support structure 112 may decrease in stiffness from a proximal end to a distal end or increase in stiffness from a proximal end to a distal end. Optionally, support structure 112 can one or more regions having a first stiffness and one or more regions having a second stiffness.

In some embodiments, the plurality of discs 114 can be attached (e.g., rigidly attached) to the support structure 112 such that movement of a disc 114 can exert force on the support structure 112, causing support structure 112 to bend, tilt, or otherwise deform. While FIG. 2 shows an exemplary robotic appendage 110 having 7 discs 114 (including disc 114a and 114b), it should be understood by a person having skill in the art that a robotic appendage 110 can comprise any number of discs 114 (e.g., 2 to 10,000, 5 to 70, 10 to 50, 20 to 30 discs). For example, the plurality of discs 114 can comprise 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 30 or more, 50 or more, 70 or more, 100 or more, 200 or more, 500 or more, 1,000 or more, 2,000 or more, 3,000 or more, 5,000 or more, 6,000 or more, 7,000 or more, 8,000 or more, 9,000 or more, or 10,000 or more discs 114. The greater the number of discs 114, the greater the degrees of freedom possible for robotic appendage 110 because, as discussed in greater detail below, robotic appendage 110 can bend, tilt, or deform at each disc 114 depending on the routing of tendons 120 through the series of discs. In some embodiments, design limitations (e.g., space constraints in the environment or space constraints due to a given task) may limit the number of discs (e.g., 10,000 or less, 9,000 or less, 8,000 or less, 7,000 or less, 6,000 or less, 5,000 or less, 4,000 or less, 3,000 or less, 2,000 or less, 1,000 or less, 500 or less, 200 or less, 100 or less, 70 or less, 50 or less, 40 or less, 30 or less, 20 or less, 15 or less, 10 or less, 9 or less, 8 or less, 7 or less, 6 or less, 5 or less, 4 or less, 3 or less) per robotic appendage.

While FIG. 2 shows the plurality of discs 114 having an equal spacing between each disc 114, it should be understood that the plurality of discs can have non-uniform spacing between each disc 114. The spacing between discs 114 can affect the bend radius of the robotic appendage. When discs 114 are small, the distance between the discs 114 can be small (e.g., about 1 mm), and when discs 114 are large, the distance between the discs 114 may be larger (e.g., about 200 mm) to preserve maneuverability of the robotic appendage 110. In some embodiments, the spacing can be about 1 mm or more, about 5 mm or more, about 10 mm or more, about 20 mm or more, about 30 mm or more, about 40 mm or more, about 50 mm or more, about 60 mm or more, about 70 mm or more, about 80 mm or more, about 90 mm or more, about 100 mm or more, about 110 mm or more, about 120 mm or more, about 130 mm or more, about 140 mm or more, about 150 mm or more, about 160 mm or more, about 170 mm or more, about 180 mm or more, about 190 mm or more, or about 200 mm or more. In some embodiments, the spacing can be about 1 mm or less, about 5 mm or less, about 10 mm or less, about 20 mm or less, about 30 mm or less, about 40 mm or less, about 50 mm or less, about 60 mm or less, about 70 mm or less, about 80 mm or less, about 90 mm or less, about 100 mm or less, about 110 mm or less, about 120 mm or less, about 130 mm or less, about 140 mm or less, about 150 mm or less, about 160 mm or less, about 170 mm or less, about 180 mm or less, about 190 mm or less, or about 200 mm or less. In some embodiments, the spacing between the discs can be between about 1 mm to about 200 mm, about 1 to about 100 mm, about 5 mm to about 100, or about 10 mm to about 50 mm.

While FIG. 2 shows the plurality of discs 114 comprising circular discs, it should be understood by a person having skill in the art that the plurality of discs may comprise discs of non-circular shapes. For example, the plurality of discs may comprise rectangular discs, elliptical discs, or polygonal discs. In some embodiments, the plurality of discs 114 can comprise discs of different shapes, sizes, widths, depths, heights, materials, or concavities. For example, with reference to FIG. 2, disc 114a may be larger or smaller than disc 114b, or disc 114a may be hexagonal while disc 114b may be elliptical. The sizing of the discs 114 can be selected to best fit a desired task.

In some embodiments, the discs may have a diameter between about 5 mm and about 500 mm, or about 20 and about 50. For example, the discs may have diameters of 5 mm or more, 20 mm or more, 24 mm or more, 50 mm or more, 75 mm or more, 100 mm or more, 125 mm or more, 150 mm or more, 175 mm or more, 200 mm or more, 225 mm or more, 250 mm or more, 275 mm or more, 300 mm or more, 325 mm or more, 350 mm or more, 375 mm or more, 400 mm or more, 425 mm or more, 450 mm or more, 475 mm or more, or 500 mm or more. For example, the discs may have diameters of 5 mm or less, 20 mm or less, 24 mm or less, 50 mm or less, 75 mm or less, 100 mm or less, 125 mm or less, 150 mm or less, 175 mm or less, 200 mm or less, 225 mm or less, 250 mm or less, 275 mm or less, 300 mm or less, 325 mm or less, 350 mm or less, 375 mm or less, 400 mm or less, 425 mm or less, 450 mm or less, 475 mm or less, or 500 mm or less.

In some embodiments, the discs 114 may have a thickness between about 0.5 mm and about 100 mm. For example, the discs 114 may have a thickness of 0.5 mm or more, 0.75 mm or more, 1 mm or more, 3 mm or more, 5 mm or more, 10 mm or more, 15 mm or more, 20 mm or more, 25 mm or more, 30 mm or more, 40 mm or more, 50 mm or more, 60 mm or more, 70 mm or more, 80 mm or more, 90 mm or more, or 100 mm or more. For example, the discs may have a thickness of 0.5 mm or less, 0.75 mm or less, 1 mm or less, 3 mm or less, 5 mm or less, 10 mm or less, 15 mm or less, 20 mm or less, 25 mm or less, 30 mm or less, 40 mm or less, 50 mm or less, 60 mm or less, 70 mm or less, 80 mm or less, 90 mm or less, or 100 mm or less.

For example, if a desired task is to remove tape, the discs 114 may be larger than if the desired task is to manufacture a wire harness. In some embodiments, if the robotic manipulator system 100 is intended to operate within tight spatial constraints, for example, the series of discs 114 can decrease in size from the base to the tip of robotic appendage 110. In some embodiments, if the robotic manipulator system 100 is intended to perform a task involving gripping an object, for example, the series of discs 114 can alternate in size, which may increase friction while robotic appendage 110 is grasping the object.

Each disc 114 of the series of discs 114 can include a plurality of routing apertures 118 configured to receive one or more tendons 120. A given tendon 120 can be routed through routing apertures 118 of multiple discs 114 of the series of discs, such that the given tendon 120 extends through the series of discs 114. In some examples, more than one tendon 120 may be routed through any given routing aperture 118. Distal ends 122 of each tendon 120 can be attached to a disc 114 of the series of discs 114. In some embodiments, the plurality of tendons may be routed in a multi-stage configuration, such that one or more distal ends 122 of the plurality of tendons may be attached to different discs of the series of discs. For example, as shown in FIG. 2, the distal end 122a of tendon 120a may be attached to disc 114a, while the distal end 122b of tendon 120b may be attached to disc 114b. In some embodiments, the plurality of tendons 120 may be routed in a full-stage configuration such that all the distal ends 122 of the plurality of tendons may all be attached to the most distal disc 114 of the series of discs 114. Actuation of the proximal end of a given tendon 120 (as described in more detail below) can create tension in the tendon 120, putting force on the series of discs 114 and causing the robotic appendage 110 to bend in the direction of the routed tendon.

In some embodiments, selective actuation of the proximal ends of tendons 120 may effectively control stiffness of the robotic appendage 110. For example, concurrent actuation of tendons 120 routed through opposite sides of a robotic appendage 110 (e.g., routed through routing apertures on opposite sides of discs 114) may effectively increase the stiffness of the robotic appendage (e.g., increasing stiffness of support structure 112) due to the opposing forces exerted on the robotic appendage 110 (e.g., exerted on discs 114 and support structure 112). This mechanism may be similar to co-contraction in human or animal physiology, where contraction of muscles on opposite sides of a joint can increase stiffness of the joint.

While FIG. 2 shows each disc 114 having 36 apertures 118 capable of receiving at least 36 tendons 120, it should be understood that each disc 114 may have any number of routing apertures 118 (e.g., between 35 to 1000, 35 to 900, 35 to 800, 35 to 700, 35 to 600, 35 to 500, 35 to 400, 35 to 300, 35 to 200, 35 to 100, 35 to 75, 50 to 1000, 75 to 1000, 100 to 1000, 200 to 1000, 300 to 1000, 400 to 1000, 500 to 1000, 600 to 1000, 700 to 1000, 800 to 1000, 900 to 1000). For example, a disc can comprise 30 or more, 40 or more, 50 or more, 60 or more, 100 or more, 200 or more, 300 or more, 900 or more, 1000 or more routing apertures 118. Increasing the number of routing apertures can increase the number of tendons that can be routed through the series of discs 114, thus increasing the overall degrees of freedom for robotic appendage 110. In some embodiments, the number of routing apertures 118 may be based on the size of the discs, the support structure, and the tendons, and a desired spacing between the routing apertures. In some embodiments, design limitations may limit the number of routing apertures 118 per disc 114 (e.g., less than 1000, less than 900, less than 800, less than 700, less than 600, less than 300, less than 200, less than 100, less than 60, less than 50, or less than 40) per disc. For example, if a disc 114 comprises a diameter of 1.5 cm, the support structure 112 has a diameter of 4 mm, the tendons 120 each have a diameter of about 1.0 mm, and the desired spacing between routing apertures 118 is approximately 1.0 mm to increase structural stability, then the disc 114 may comprise up to about 53 routing apertures. In another example, if a disc 114 comprises a diameter of 2 cm, the support structure 112 has a diameter of 4 mm, the tendons 120 each have a diameter of about 1 mm, and the desired spacing between routing apertures 118 is approximately 1.0 mm to increase structural stability, then the disc 114 may comprise up to about 96 routing apertures. In some embodiments, the routing apertures may be reinforced to increase structural stability.

While FIG. 2 shows each disc 114 having the same number of routing apertures 118, it should be understood that a given disc 114 (e.g., disc 114a) may have a greater number of routing apertures 118 than another disc 114 (e.g., disc 114b). While FIG. 2 shows each disc 114 having routing apertures 118 arranged in the same pattern, it should be understood that each disc 114 can have routing apertures 118 arranged in different patterns. The arrangement of routing apertures 118 may be task dependent to allow robotic appendage 110 to bend, tilt, or otherwise deform in directions well-suited to a given task. Further, while FIG. 2 shows each routing aperture 118 with one tendon 120 routed through, it should be understood that any given routing aperture 118 may have multiple tendons 120 routed through the routing aperture 118. In some embodiments, more than one tendon 120 may be routed along the same path for redundancy.

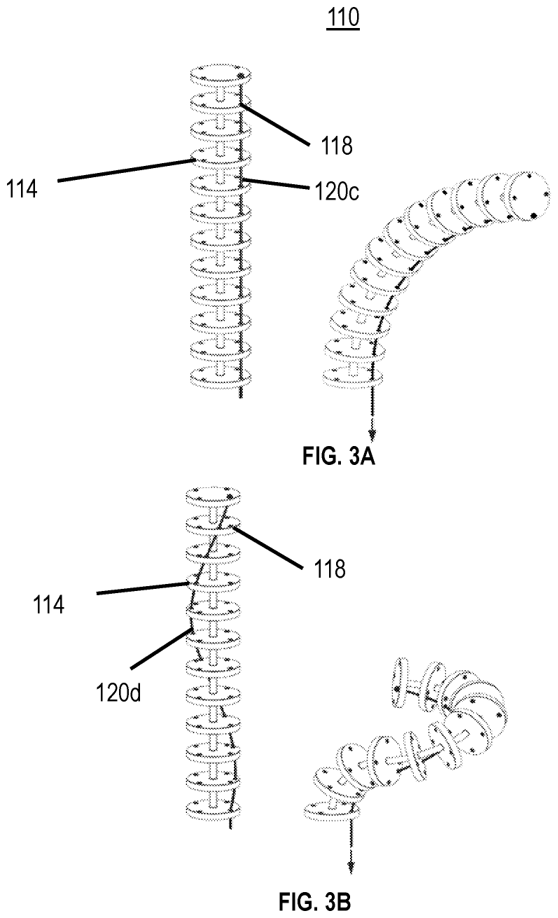

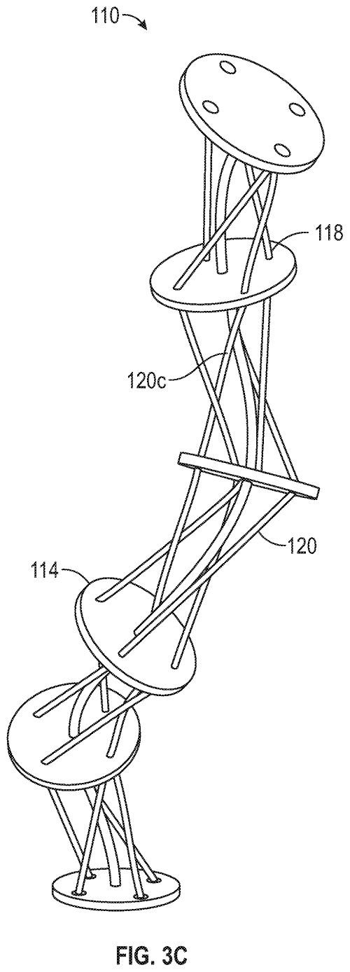

While FIG. 2 shows all the tendons 120 routed in a parallel path through the series of discs with respect to the support structure, it should be understood that one or more tendons 120 can be routed in a non-parallel fashion. For example, one or more tendons 120 may be routed through the series of discs 114 in a helical manner, a converging manner, or an arbitrary manner. The routing patterns of the one or more tendons may be task dependent. Non-parallel routing of tendons 120 through the series of discs 114 can allow robotic appendage 110 to bend in more directions than a robotic appendage 110 having only parallel routing. A robotic appendage 110 having tendons routed in varied ways (e.g., parallel, helical, converging, or arbitrary, or any combination thereof) can achieve motion primitives not feasible by conventional robotic systems. FIG. 3A shows examples of a tendon 120c with parallel routing and how subsequent actuation of tendon 120c can cause robotic appendage 110 to bend along the path of tendon 120c. FIG. 3B shows examples of a tendon 120d with helical routing and how subsequent actuation of tendon 120d can cause robotic appendage 110 to bend in a different manner than actuation of tendon 120c, such that robotic appendage 110 bends in a different planar direction at each disc 114. FIG. 3C shows an example of non-parallel routing of multiple tendons 120 through a series of discs. As shown in FIG. 3C, all of the tendons 120 may be routed in a helical manner through robotic appendage 110, and when a tendon 120 (e.g., tendon 120e) is actuated, robotic appendage 110 can bend in a different planar direction at each disc 114. In some embodiments, a robotic appendage 110 can have combinations of tendons arranged in parallel routes, helical routes, converging routes, and arbitrary routes. In some embodiments, the routing configurations of the plurality of tendons can be selected by a machine learning, deep learning, or artificial intelligence algorithm to optimize a robotic appendage 110 for a given task.

Referring back to FIG. 2, robotic appendage 110 can include a sleeve 119 disposed around the series of discs 114 and the support structure 112. In some embodiments, the sleeve 119 can be bonded to the perimeters of the series of discs 114 and the base plate 116. The sleeve 119 can be made of an elastomer (e.g., silicone, rubber, polytetrafluoroethylene, or any other synthetic elastomer). The sleeve 119 can protect the inner components of the robotic appendage 110, such as the support structure 112, the series of discs 114, and the plurality of tendons 120. In some embodiments, sleeve 119 can provide good contact between the robotic appendage 110 and an object during a manipulation task. For example, sleeve 119 may increase friction between the robotic appendage 110 and an object, which may improve the gripping ability of the robotic appendage 110. In some embodiments, robotic appendage 110 can be cast in an elastomeric fill material for filling the interior of robotic appendage 110. Casting robotic appendage 110 with an elastomeric fill material can provide support and stability to robotic appendage 110. Though the elastomeric fill material can surround the tendons 120, the elasticity of the elastomeric fill material may still allow robotic appendage 110 to bend and twist.

In some embodiments, the robotic appendage 110 can include a base plate 116. Base plate 116 can comprise a plurality of routing apertures 118 for the plurality of tendons 120. Base plate 116 may allow robotic appendage 110 to be secured to a surface, such as workbench 150 or to another robotic component (e.g., a robotic arm). In some embodiments, base plate 116 may allow robotic appendage 110 to be secured to a gripper base 162 configured to couple one or more robotic appendages together.

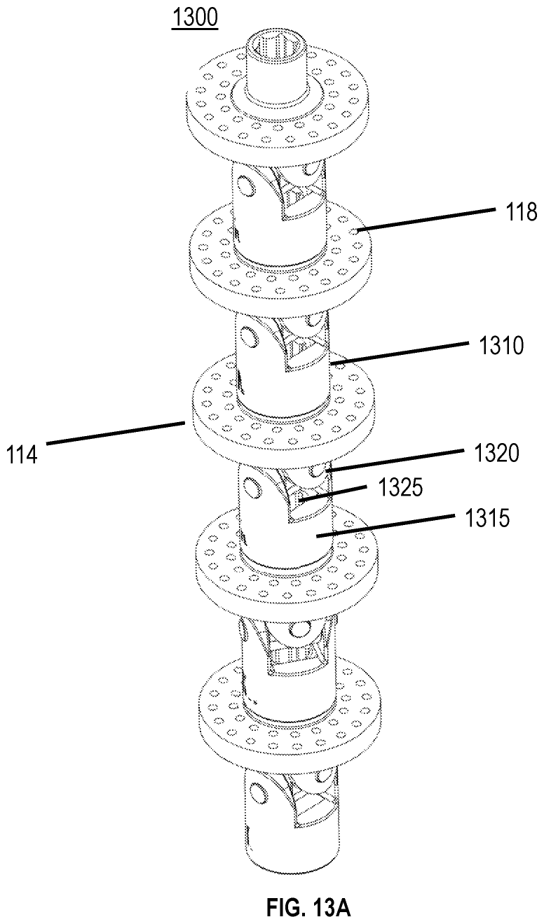

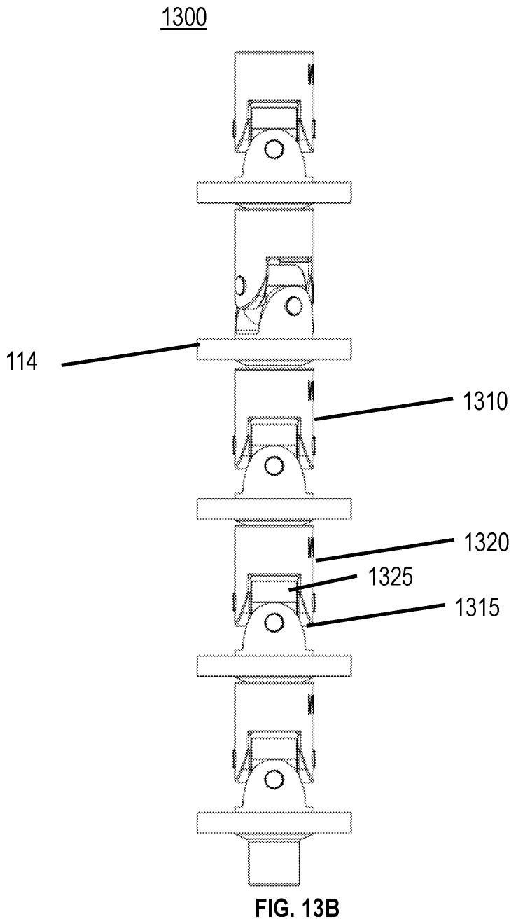

FIG. 13A and FIG. 13B show perspective and top views, respectively of another exemplary robotic appendage 1300. In some embodiments, robotic manipulator system 100 may include robotic appendage 1300 alternatively or additionally to robotic appendage 110. Robotic appendage 1300 can differ from robotic appendage 110 in that, instead of a support structure 112, robotic appendage 1300 comprises a series of joints 1310 (e.g., universal joints) and a series of discs 114 arranged along a longitudinal axis of the series of joints 1310, and a plurality of tendons (not shown) extending through the series of discs 114. Joints 1310 may each comprise a first shaft 1315 connected to a second shaft 1320 by a cross 1325, such that the first shaft 1315 and the second shaft 1320 can pivot relative to each other at the cross 1325. The first shaft 1315 of a joint 1310 can connect to one disc 114 in the series of discs 114 and the second shaft 1320 can connect to the next disc 114 in the series of discs 114, such that movement of a disc 114 can exert force on the attached shaft, causing the shaft to bend or pivot, and the overall robotic appendage 1310 to bend, tilt, or otherwise deform.

With the exception of the support structure 112, robotic appendage 1300 may comprise any one or more features of robotic appendage 110. For example, the series of discs 114 can include a plurality of routing apertures 118 configured to receive one or more tendons. The one or more tendons can be routed through the routing apertures 118 in a parallel manner, a helical manner, a converging manner, or an arbitrary manner. In some embodiments, robotic appendage 1300 can include a sleeve disposed around the series of discs 114 and the series of joints 1310 similarly to sleeve 116 of robotic appendage 110.

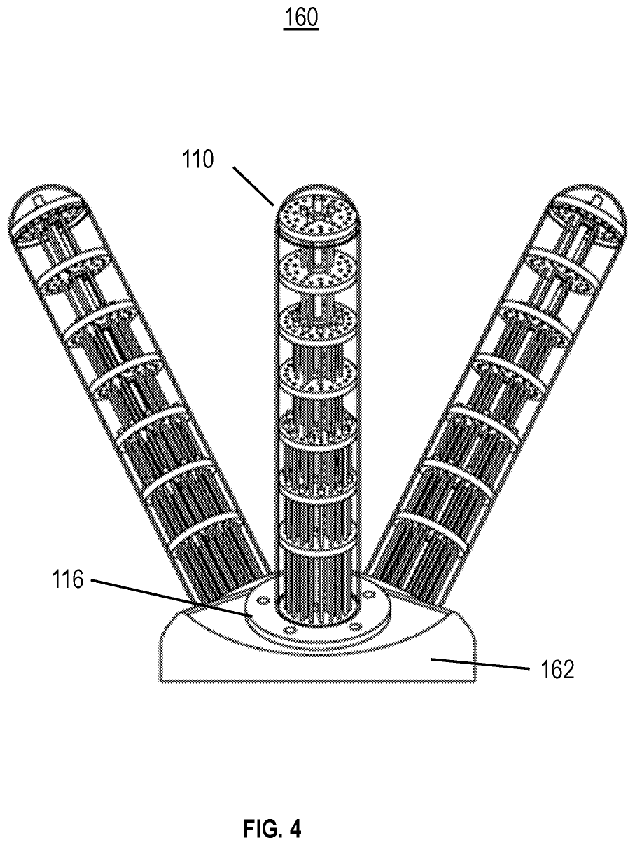

More than one robotic appendage 110 (or more than one robotic appendage 1300) can be coupled together to form a gripper (e.g., gripper 160 of FIG. 1). FIG. 4 shows a perspective view of an exemplary gripper 160 (e.g., end effector). In an exemplary embodiment, gripper 160 can include a plurality of robotic appendages 110, wherein the base plate 116 of each robotic appendage 110 can be secured to a gripper base 162. While FIGS. 1 and 4 show gripper 160 having 3 robotic appendages 110, it should be understood that gripper 160 can include any number of robotic appendages 110 (e.g., 2 to 100, 2 to 50, 2 to 30, 2 to 20, 2 to 15, 2 to 10, 2 to 9, 2 to 8, 2 to 7, 2 to 6, 2 to 5, 2 to 4, 3 to 40, 4 to 30, 5 to 20). For example, gripper 160 can include 2 or more, 3 or more, 4 or more, 5 or more, 10 or more, 15 or more, 20 or more, 50 or more, 75 or more, or 100 or more robotic appendages 110 coupled to a gripper base 162. In some embodiments, design limitations (e.g., space constraints in the environment or space constraints due to a given task) may limit the number of robotic appendages per gripper 160 (e.g., 100 or less, 75 or less, 50 or less, 40 or less, 30 or less, 20 or less, 15 or less, 10 or less, 9 or less, 8 or less, 7 or less, 6 or less, 5 or less, 4 or less, 3 or less). While FIG. 4 shows gripper 160 configured such that the longitudinal axes of each robotic appendage 110 are non-parallel, it should be understood that the surface of gripper base 162 may be planar such that the longitudinal axes of each robotic appendage 110 are parallel.

Movement of a robotic appendage 110 can be controlled by selective actuation of one or more tendons 120 in the plurality of tendons 120. A tendon 120 can be actuated by an actuator 140. In some embodiments, actuator 140 may comprise a linear actuator configured to pull the proximal end of a tendon 120. For example, a linear actuator can pull a flexible, semi-rigid, or fully-rigid tendon 120. In some embodiments, actuator 140 may be a capstan-based actuator. FIGS. 5A and 5B illustrate an exemplary capstan-based actuator 140 engaging the proximal end 124 of a tendon 120. Actuator 140 can include a motor 142, a shaft 144, a capstan 146 for securing the proximal end 124 of tendon 120, a bracket 148, and a strain gauge 149. An actuator control unit 175 attached to the actuator grid housing actuator 140 can be configured to control motor 142. Computing system 170 may control motor 142 by sending control signals to motor 142. In some embodiments, motor 142 can comprise a DC motor, a stepper motor, or a servo motor, or any other motor that can tighten the tension of a tendon 120. For example, motor 142 can be a DC motor comprising a rotating shaft 144.

A bracket 148 can be attached to the motor 142. In some embodiments, bracket 148 can be made of sheet metal. In some embodiments, bracket 148 can be a spooling bracket. Bracket 148 can house a capstan 146 rigidly coupled to shaft 144. The capstan 146 can be configured to secure the proximal end of a tendon 120, with a portion of the tendon 120 spooled onto the capstan 146. In some embodiments, tendon 120 may be fully flexible, such that actuation of tendon 120 causes a change in tension of tendon 120. As the shaft 144 rotates, the capstan 146 also rotates, either winding tendon 120 on the capstan 146 (retracting tendon 120 and increasing tension in tendon 120) or unwinding tendon 120 on the capstan (decreasing tension in tendon 120). If tendon 120 is fully flexible, extension of tendon 120 can be caused by the resistance of robotic appendage 110 to deformation caused by an earlier actuation of tendon 120. For example, unwinding of tendon 120 may cause loosening of tendon 120, and the force of the resistance of robotic appendage 110 to deformation may exert a pulling force on tendon 120, causing extension of tendon 120. In some examples, the robotic appendage 110 may exert a pulling force on tendon 120 due to actuation of a different tendon 120 or other forces applied to the robotic appendage 110.

In some embodiments, tendon 120 may be semi-rigid such that actuation of tendon 120 can cause either a change in tension or compression. For example, winding tendon 120 on capstan 146 may cause an increase in tension, while unwinding tendon 120 on capstan 146 may cause extension of tendon 120 due to compression. An increase in tension of tendon 120 can cause robotic appendage 110 to bend, tilt, or otherwise deform at each disc 114 in the direction of tendon 120 due to a pulling force exerted by tendon 120 on the series of discs 114. An increase in compression of tendon 120 can cause robotic appendage 110 to bend, tilt, or otherwise deform in a direction away from tendon 120 due to a pushing force exerted by tendon 120 on the series of discs 114.

In some embodiments, actuator 140 may comprise one or more sensors. For example, motor 142 may comprise torque sensors, current sensors, temperature sensors, position sensors, or force sensors. In some embodiments, motor 142 can include an optical relative position encoder. In some embodiments, actuator 140 can include strain gauge 149. Strain gauge 149 can measure the tension in tendon 120. Tension in tendon 120 causes the sheet metal of strain gauge 149 at point 143 to bend, which can change the resistance of strain gauge 149. Sensor measurements (e.g., from optical relative position encoder and strain gauge 149) can be transmitted to actuator control unit 175. Actuator control unit 175 may transmit received sensor measurements to computing system 170, which can monitor performance of an actuator 140 based on the sensor measurements. Computing system 170 can also generate control signals for actuator control unit 175 based on the received sensor measurements.

In some embodiments, actuator 140 may be sized such that many actuators 140 can fit in a limited space. For example, an actuator 140 may be between about 10 mm and about 100 long, between about 10 mm and about 100 mm wide, and about 10 mm and about 100 mm tall. In some embodiments, actuators 140 and tendons 120 may be modular. For example, actuators 140 and tendons 120 can be added to or removed from robotic manipulator system 100 by an end user. In some examples, all the actuators 140 may be identical, which may reduce manufacturing and/or repair costs of the robotic manipulator system 100.

In some embodiments, actuator 140 may comprise a constant force spring such that the actuator is spring-loaded. In a spring-loaded actuator, the natural state of the tendon 120 may be fully or partially retracted (e.g., similar to a draw wire encoder). This may help with management, organization, and/or assembly of the robotic manipulator system 100.

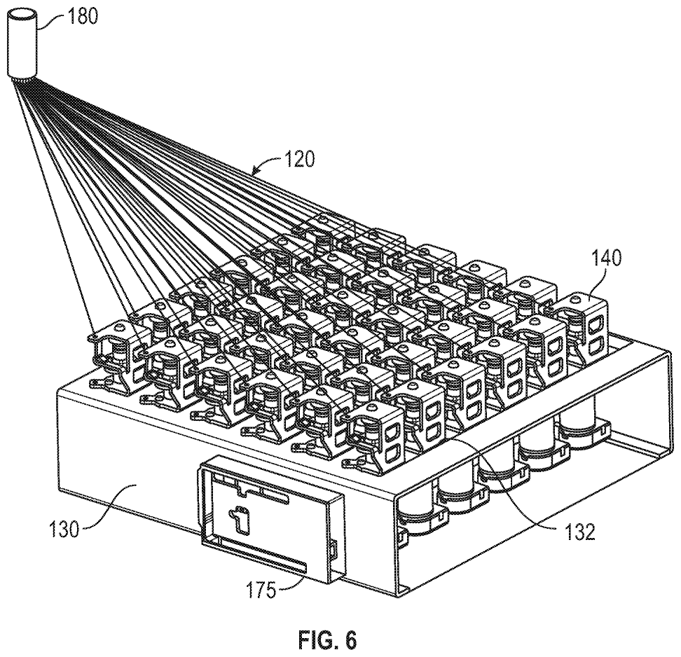

Actuators 140 may be arranged in an actuator grid 130. FIG. 6 illustrates a perspective view of an exemplary actuator grid 130 and an actuator control unit 175. An actuator grid 130 can comprise an arrangement of a large number (e.g., 30 or more, 40 or more, 50 or more, 60 or more, 100 or more, 200 or more, 300 or more, 900 or more, 1000 or more) of actuators 140. As discussed above, while the disclosed systems can incorporate a large number of individually actuated tendons due to reduced space constraints enabled by the separation of actuators and robotic appendages, in some embodiments, design limitations (e.g., space constraints in the environment or space constraints due to a given task) may limit the number of actuators 140 (e.g. less than 1000, less than 900, less than 800, less than 700, less than 600, less than 300, less than 200, less than 100, less than 60, less than 50, or less than 40) per actuator grid 130. As discussed previously, actuators 140 may be modular, such that actuators 140 can be removed or added from the slots 132 of actuator grid 130.

In some embodiments, actuator grid 130 can comprise 35 or more slots 132 for accommodating 35 or more actuators. While FIG. 5 shows an actuator grid 130 comprising 36 slots accommodating an arrangement of 36 actuators 140, it should be understood that actuator grid 130 can comprise an arrangement of any number of slots 132 (e.g., 35 to 40, 35 to 50, 35 to 60, 35 to 100, 35 to 200, 35 to 300, 35 to 600, 35 to 700, 35 to 800, 35 to 900, or 35 to 1000). For example, each actuator grid 130 can include 35 or more slots 132, 45 or more slots 132, 55 or more slots 132, 65 or more slots 132, 75 or more slots 132, 85 or more slots 132, 95 or more slots 132, 100 or more slots 132, 125 or more slots 132, 150 or more slots 132, 175 or more slots 132, 200 or more slots 132, 225 or more slots 132, 250 or more slots 132, 275 or more slots 132, 300 or more slots 132, 325 or more slots 132, 350 or more slots 132, 375 or more slots 132, 400 or more slots 132, 425 or more slots 132, 450 or more slots 132, 475 or more slots 132, 500 or more slots 132, 525 or more slots 132, 550 or more slots 132, 575 or more slots 132, 600 or more slots 132, 625 or more slots 132, 650 or more slots 132, 675 or more slots 132, 700 or more slots 132, 725 or more slots 132, 750 or more slots 132, 775 or more slots 132, 800 or more slots 132, 825 or more slots 132, 850 or more slots 132, 875 or more slots 132, or 900 or more slots 132. In some embodiments, design limitations (e.g., space constraints in the environment or space constraints due to a given task) may limit the number of slots 132 (e.g. less than 1000, less than 900, less than 800, less than 700, less than 600, less than 300, less than 200, less than 100, less than 60, less than 50, or less than 40) per actuator grid 130.

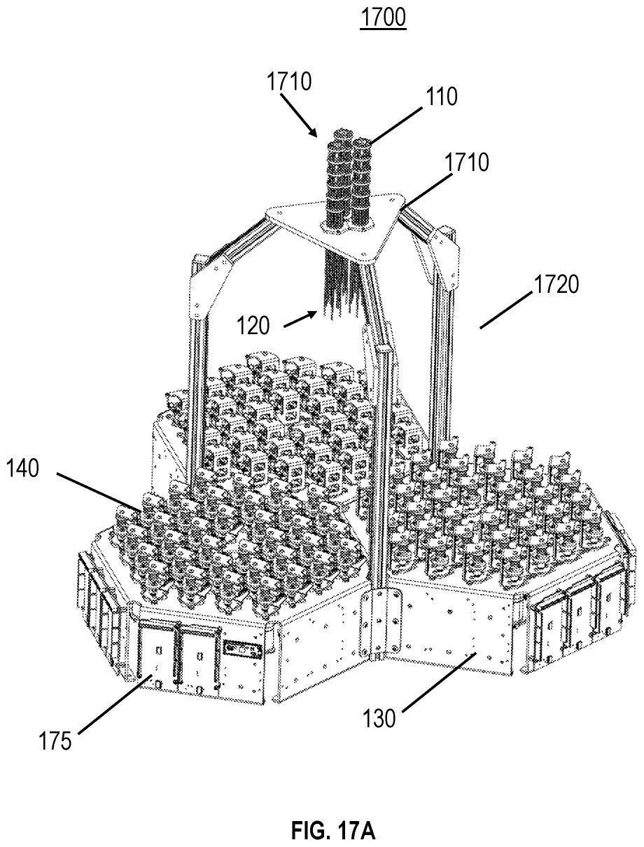

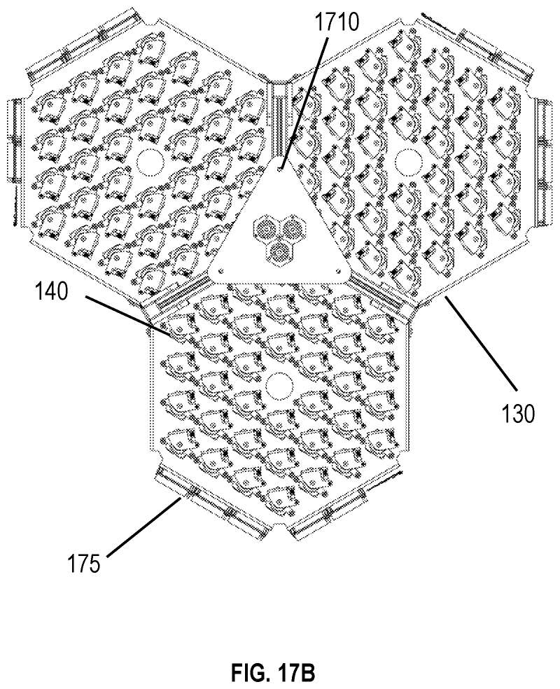

While FIG. 6 shows actuator grid 130 comprising a square arrangement of slots 132 (e.g., an arrangement of 6 by 6 slots 132), it should be understood that actuator grid 130 may comprise other shapes. For example, actuator grid 130 may comprise a rectangular arrangement of slots (e.g., 25 by 30 slots 132 or 15 by 6 slots 132). In another example, actuator grid 130 may comprise a honeycomb (e.g., hexagonal) shape comprising a honeycomb (e.g., hexagonal) arrangement of slots (e.g., as shown in FIG. 17A and FIG. 17B, discussed in more detail below). In some embodiments, actuator grid 130 may comprise slots 132 arranged in concentric circles. While FIG. 5 shows actuator grid 130 comprising a planar top surface such that all the actuators 140 are arranged parallel to each other (e.g., such that the longitudinal axes of the actuators 140 are parallel to each other), it should be understood that actuator grid 130 may have a non-planar top surface. For example, the top surface of actuator grid 130 may comprise a concave shape.

In some embodiments, actuator grid 130 can be separate from the robotic appendage 110. For example, actuator grid 130 may be connected to the robotic appendage only through the plurality of tendons. In some embodiments, the actuator grid may be separate from the from the gripper 160. For example, the actuator grid can be located on a robotic arm or workbench supporting the robotic appendage 110 and/or gripper 160. In some embodiments, the actuator grid 130 can be separate from a robotic arm or workbench supporting the robotic appendage 110 and/or gripper 160. For example, the actuator grid 130 may be located in a different portion of the room, in a different room, or in a different building from the robotic appendage 110, gripper 160, robotic arm, work bench, and/or chassis of the robotic system 100. Separation of the actuator grid 130 from the robotic appendage 110 can allow larger space for the actuator grid 130, in contrast to conventional robotic systems where actuators are limited by the form factor of the conventional robotic system. A larger actuator grid 130 can house more actuators 140, which can allow for control of more tendons 120, increasing the degrees of freedom for robotic appendage 110 over conventional robotic systems. For example, conventional robotic systems which position actuators on the robot itself are limited to 16 to 24 actuators per robotic hand. In contrast, the disclosed systems, by separating the actuator grid 130 from the robotic appendage 110, can include a large number of actuators (e.g., 30 or more, 35 or more, 40 or more, 50 or more, 60 or more, 100 or more, 200 or more, 300 or more, 900 or more, 1000 or more, etc.) per robotic appendage 110. For example, the disclosed systems can include 35-900 actuators per robotic appendage 110 such that a system including a gripper 160 with 3 robotic appendages 110 can reach 105-2,700 degrees of freedom.

While FIG. 1 shows one actuator grid 130 for each robotic appendage 110, it should be understood that actuator grids 130 and robotic appendages 110 can be configured in other arrangements. For example, a robotic appendage 110 may comprise a plurality of tendons 120, and two or more actuator grids 130 may collectively engage the proximal ends of the plurality of tendons, such that there may be two or more actuator grids 130 controlling actuation of one robotic appendage. In another example, a gripper 160 may comprise a first robotic appendage 110 comprising a first plurality of tendons 120 and a second robotic appendage 110 comprising a second plurality of tendons 120, and one actuator grid 130 may engage the proximal ends of both the first and second plurality of tendons.

In some embodiments, a robotic manipulator system can include any number of actuator grids 130 (e.g., 1 or more, 2 or more, 3 or more, 4 or more, 5 or more, 10 or more, 15 or more, 20 or more, 50 or more). In some embodiments, design limitations (e.g., space constraints in the environment or space constraints due to a given task) may limit the number of actuator grids 130 (e.g., 50 or less, 40 or less, 30 or less, 20 or less, 15 or less, 10 or less, 9 or less, 8 or less, 7 or less, 6 or less, 5 or less, 4 or less, 3 or less).

Frictional forces can be generated between the gathered tendons 120 in tube 180 or between the tendons 120 and the interior surface of tube 180. Frictional forces can cause latency or lags between actuation of a tendon 120 by an actuator 140 and resulting motion of robotic appendage 110 due to that actuation. For example, frictional forces can impact force transmission between the actuators 140 and the robotic appendage 110. Reduced force transmission may create deadbands (e.g., regions where changes in actuation do not cause a corresponding change in the robotic appendage 110 or gripper 160). In some embodiments, robotic manipulator system 100 may be configured to reduce friction between elements of the robotic manipulator system 100 (e.g., to reduce latency, to reduce deadbands, to increase force transmission, to reduce heat produced by friction between tendons 120, and/or to limit power draw from actuators 140).

For example, in some embodiments, robotic manipulator system 100 may comprise one or more tubes 180 positioned in between a robotic appendage 110 and an actuator grid 130, wherein at least one tube 180 can be configured to gather one or more tendons 120 of the plurality of tendons 120. The one or more tubes 180 can reduce loss of force between the actuators 140 and the robotic appendage 110 due to friction. In some embodiments, a tube 180 can be rigid. For example, a tube 180 can comprise metals (e.g., steel or aluminum) or rigid polymers (e.g., polyethylene terephthalate (PET), polystyrene, or polyvinyl chloride (PVC)). In some embodiments, a tube 180 can be flexible. For example, a tube 180 can comprise a low-friction elastomer (e.g., silicon or polytetrafluoroethylene).

In some embodiments, a tube 180 can gather 1 to 1000 tendons 120. In some embodiments, the robotic manipulator system 100 may comprise 1 to 100 tubes 180. For example, robotic manipulator system may comprise 1 or more, 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 30 or more, 50 or more, 70 or more, 100 or more tubes 180. For example, robotic manipulator system may comprise 1 or less, 2 or less, 3 or less, 4 or less, 5 or less, 6 or less, 7 or less, 8 or less, 9 or less, 10 or less, 11 or less, 12 or less, 13 or less, 14 or less, 15 or less, 16 or less, 30 or less, 50 or less, 70 or less, 100 or less tubes 180.

In some embodiments, at least one tube of the one or more tubes 180 may be configured to gather other tubes 180, such that the plurality of tendons can be hierarchically gathered. For example, a first tube 180 may gather a set of 10 tendons 120, and a second tube 180 may gather a different set of 10 tendons 120. A third tube 180 may be larger than the first and second tubes may gather the first and second tubes 180. In another example, robotic manipulator system 100 can comprise a first set of tubes 180, with each of the first set of tubes gathering a single tendon 120. The first set of tubes can be gathered by a second set of tubes 180, with each tube 180 in the second set of tubes 180 gathering 2 or more tubes of the first set of tubes. The tendons 120 can be hierarchically gathered based on function and/or ease of assembly. For example, the tendons from one robotic appendage 110 can be bundled together for ease of management and/or assembly of robotic manipulator system 100. Hierarchical gathering of tendons 120 can aid in management of tendons, assembly of robotic manipulator system 100, and/or facilitate debugging if robotic manipulator system malfunctions. 120. In some embodiments, the robotic manipulator system 100 can comprise at least one tube per actuator grid 130. For example, if robotic manipulator system 100 comprises 3 actuator grids 130, robotic manipulator system 100 may comprise at least 3 tubes 180 to gather the three sets of tendons 120 extending from the actuators 140 arranged in each actuator grid 130. In some embodiments, the robotic manipulator system 100 can comprise at least one tube per robotic appendage 110. For example, if robotic manipulator system 100 comprises 3 robotic appendages 110, robotic manipulator system 100 may comprise at least 3 tubes 180 to gather the three sets of tendons 120 extending from each actuator grid 130.

In some embodiments, the robotic manipulator system 100 can include any number of tubes 180 (e.g., 1 or more, 2 or more, 3 or more, 4 or more, 5 or more, 10 or more, 15 or more, 20 or more, 50 or more). In some embodiments, design limitations (e.g., space constraints in the environment or space constraints due to a given task) may limit the number of tubes (e.g., 50 or less, 40 or less, 30 or less, 20 or less, 15 or less, 10 or less, 9 or less, 8 or less, 7 or less, 6 or less, 5 or less, 4 or less, 3 or less).

In some embodiments, at least one tube 180 can include a lubricated interior surface configured to reduce frictional force between the gathered one or more tendons 120 and/or between the gathered one or more tendons 120 and the lubricated interior surface of the at least one tube 180. For example, the interior surface of tube 180 can be coated with liquid lubricants (e.g., oils or greases). In some embodiments, where a given tube 180 gathers one or more smaller tubes 180, a lubricated interior surface may reduce frictional force between the gathered one or more tubes 180. In some examples, the inner surface of tube 180 can be surface treated to reduce friction. For example, the inner surface of tube 180 can be mechanically smoothed or coated with friction-reducing coatings (e.g., Teflon). In some embodiments, tubes 180 can comprise materials with low coefficients of friction between the tubes 180 and the tendons 120.

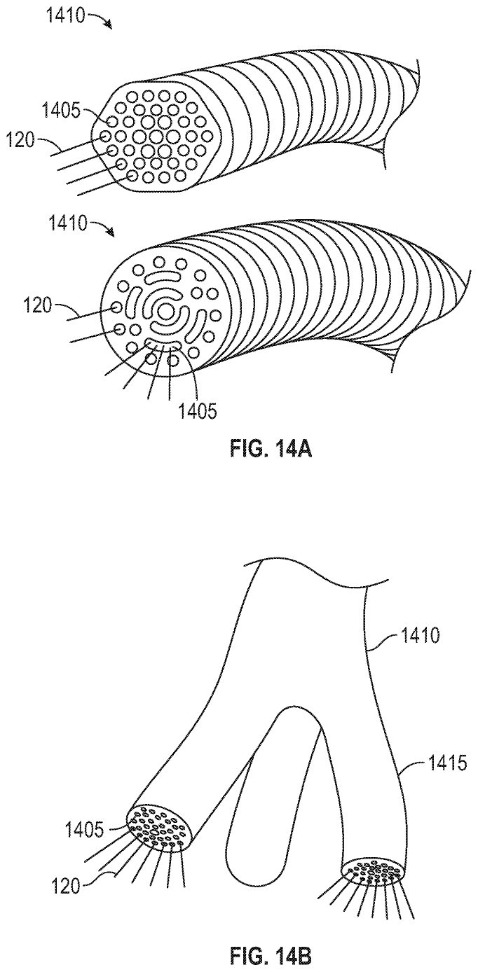

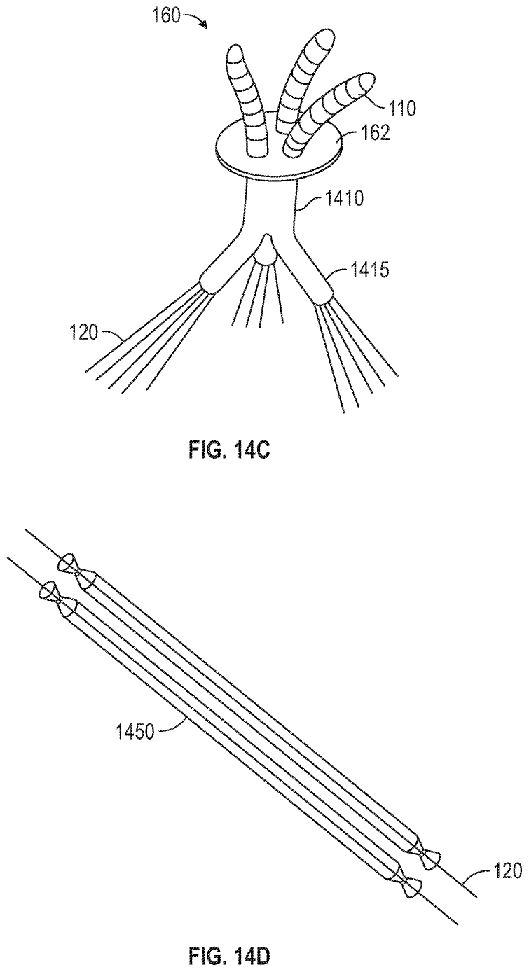

In some embodiments, as shown in FIGS. 14A-14C, a tube 180 may be a lumen tube 1400 comprising a plurality of lumens 1405 extending through the lumen tube. The plurality of lumens 1405 can be configured to receive one or more tendons 120. The inner surfaces of the lumens 1405 may be smooth, such that there is little friction between the tendons 120 and the inner surface of the lumens 1405. In some embodiments, a lumen tube 1410 may be configured to receive one tendon 120 per lumen 1405. In some embodiments, a lumen tube 1410 may be configured to receive a plurality of tendons 120 per lumen 1405. In some embodiments, a lumen tube 1410 may comprise one or more lumens 1405 configured to receive 1 tendon 120 and one or more lumens 1405 configured to receive a plurality of tendons 120. A lumen tube 1410 may be configured to be flexible. For example, a lumen tube 1410 may comprise plasticizer-free block copolymer thermoplastic elastomer, polyamide, polyurethane, polyester, or other thermoplastic elastomer materials.

In some embodiments, as shown in FIG. 14B and FIG. 14C, a lumen tube 1410 can branch into sub-lumen tubes 1415. A first plurality of tendons extending from one actuator grid can be routed through a first sub-lumen tube 1415, a second plurality of tendons extending from a second actuator grid can be routed through a second sub-lumen tube 1415, and a third plurality of tendons extending from a third actuator grid can be routed through a third sub-lumen tube 1415. The distal ends three sub-lumen tubes 1415 can be merged into one lumen-tube 1410. In some embodiments, the distal end of the lumen-tube can direct the plurality of tendons into a gripper 160 or a robotic appendage 110. While FIG. 14B and FIG. 14C show one lumen tube 1410 branching into three sub-lumen tubes 1415, it should be understood that a lumen tube 1410 can branch into any number of sub-lumen tubes 1415 (e.g., 1 or more, 2 or more, 3 or more, 4 or more, 5 or more, 10 or more, 15 or more, 20 or more, 50 or more). In some embodiments, design limitations (e.g., space constraints in the environment or space constraints due to a given task) may limit the number of sub-lumen tubes 1415 (e.g., 50 or less, 40 or less, 30 or less, 20 or less, 15 or less, 10 or less, 9 or less, 8 or less, 7 or less, 6 or less, 5 or less, 4 or less, 3 or less).

In some embodiments, robotic manipulator system 100 may comprise a plurality of metallic sleeves 1400 for reducing or eliminating friction between the plurality of tendons 120. As shown in FIG. 14D, one or more metallic sleeves 1450 may be installed over each tendon 120. In some embodiments, the metallic sleeves 1450 may be crimped at various positions to facilitate attachment between a metallic sleeve 1450 and a tendon 120. While FIG. 14D shows a crimp at either end of each metallic sleeve 1450, it should be understood that the crimps can be located at any position of the metallic sleeve 1450. The metallic sleeves 1450 may have a smooth surface, such that friction between tendons 120 may be reduced at locations where the metallic sleeves 1450 are installed. The metallic sleeves 1450 may be installed at regions of the tendons 120 where the tendons 120 do not need to bend or flex (e.g., regions of tendons 120 where the tendons 120 remain straight or linear). For example, the metallic sleeves 1400 may be installed where the tendons 120 enter a gripper base 162, a gripper 160, and/or a robotic appendage 110 or 1300. For example, the metallic sleeves 1450 may be attached where the tendons 120 exit the actuators 140. For example, the metallic sleeves 1450 may be attached where the tendons 120 are gathered by the tube 180.

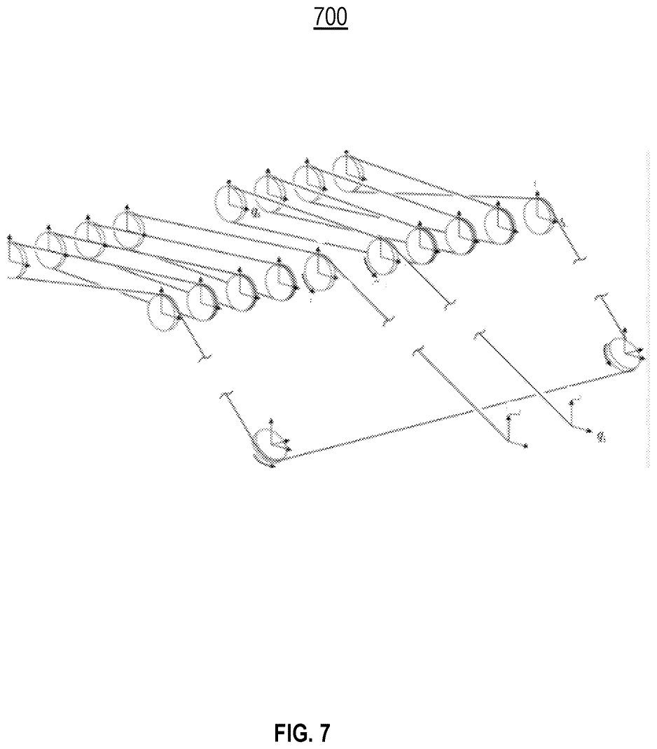

In some embodiments, robotic manipulator system 100 may include a pulley system 700, as illustrated in FIG. 7, positioned in between the robotic appendage 110 and the actuator grid 130. The pulley system 700 may engage the plurality of tendons 120 such that each tendon 120 of the plurality of tendons 120 can be separated from other tendons 120 in the plurality of tendons 120, such that there may be no friction for the portions of the tendons 120 separated by the pulley system.

In some embodiments, actuator grid 130 may be configured to reduce friction between elements of robotic manipulator system 100. For example, actuator grid 130 can have a hemispherical, concave top surface and a tube 180 may be positioned above the approximate center of the hemisphere, such that the actuators 140 can be arranged to direct tendons 120 radially to the tube 180. This arrangement may create uniform friction where the tendons come out of the actuators 140. For example, one source of friction may be contact between a tendon 120 and the motor bracket 148 of an actuator 140, such that the friction may be dependent on the angle of contact between the tendon 120 and the actuator 140. If the actuators 140 are arranged in a concave manner, then there may be a constant angle between the tendons 120 and the actuators 140, such that the component of friction due to the contact between tendon 120 and actuator 140 is uniform (or approximately uniform) across all the tendons 120.

In some embodiments, robotic manipulator system 100 may be configured to produce or maintain friction between elements of the robotic manipulator system 100. For example, in some embodiments, at least one tube 180 can include a roughened interior surface configured to increase frictional force between tendons 120 of the plurality of tendons 120 and/or between the gathered one or more tendons 120.

In some embodiments, friction between elements of the robotic manipulator system 100 may not interfere with the function of robotic manipulator system 100 because the robotic manipulator system 100 may be controlled by a machine learning, deep learning, or artificial intelligence model, which can have the ability to learn complex, non-linear relationship from large datasets. The machine learning, deep learning, or artificial intelligence model may be able to identify patterns and make accurate predictions about frictional forces within robotic manipulator system 100 without requiring explicit mathematical formulations.

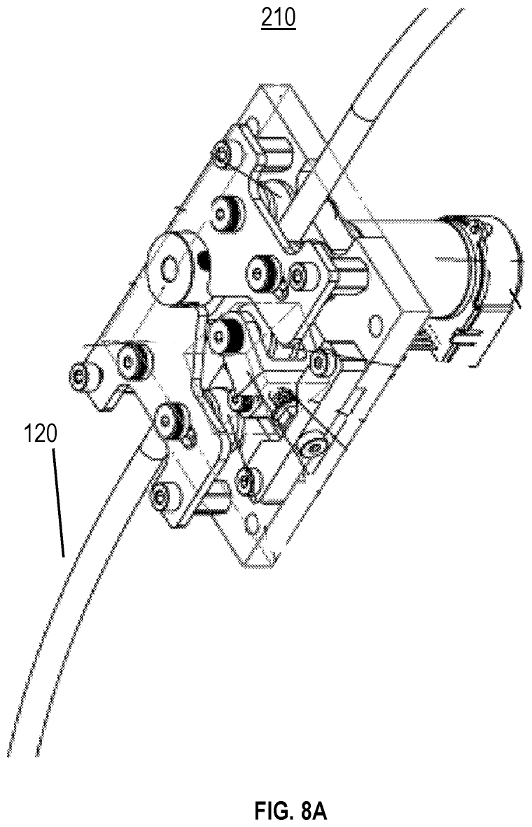

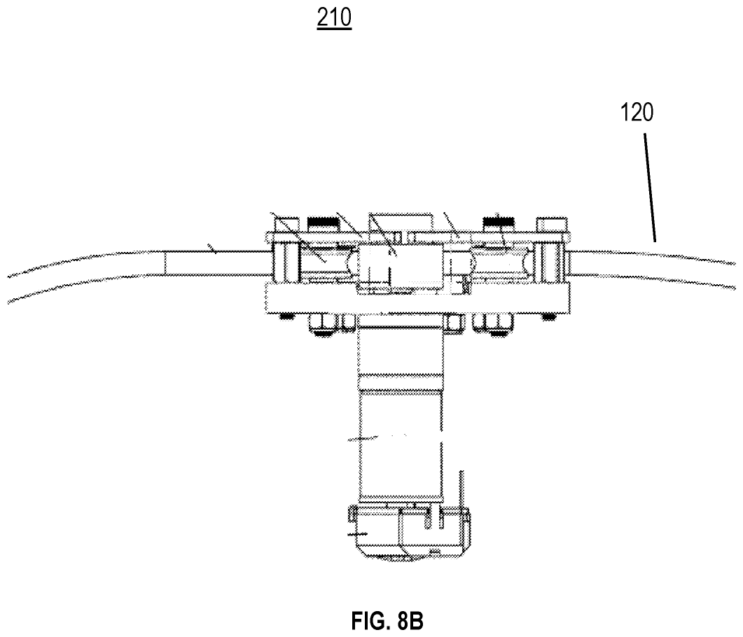

In some embodiments, robotic manipulator system 100 may include shooter assemblies 210 additionally or alternatively to actuators 140. Shooter assemblies 210 are described in U.S. patent application Ser. No. 18/765,150, titled “Automated picking apparatus for fruits and other delicate objects and method therefor,” filed Jul. 5, 2024, incorporated herein by reference for all purposes. FIGS. 8A and 8B illustrate perspective and side views of an exemplary shooter assembly 210, respectively. Shooter assemblies 210 can include a motor to move tendon 120 back and forth within shooter assembly 210, either increasing or decreasing tension in tendon 120. Shooter assemblies 210 can control actuation of flexible, semi-rigid, or fully-rigid tendons 120. When tendons 120 are semi-rigid or fully rigid, the shooter assemblies 210 can also increase or decrease compression in the tendons 120.

Robotic manipulator system 100 may include a large number of shooter assemblies 210 (e.g., 30 or more, 35 or more, 40 or more, 50 or more, 60 or more, 100 or more, 200 or more, 300 or more, 900 or more, 1000 or more, 2000 or more, or 3000 or more) per robotic appendage 110. While the disclosed systems can incorporate a large number of shooter assemblies 210 due to reduced space constraints enabled by the separation of shooter assemblies 210 and robotic appendages, in some embodiments, design limitations (e.g., space constraints in the environment or space constraints due to a given task) may limit the number of shooter assemblies 210 (e.g. less than 1000, less than 900, less than 800, less than 700, less than 600, less than 300, less than 200, less than 100, less than 60, less than 50, or less than 40) per robotic appendage 110.

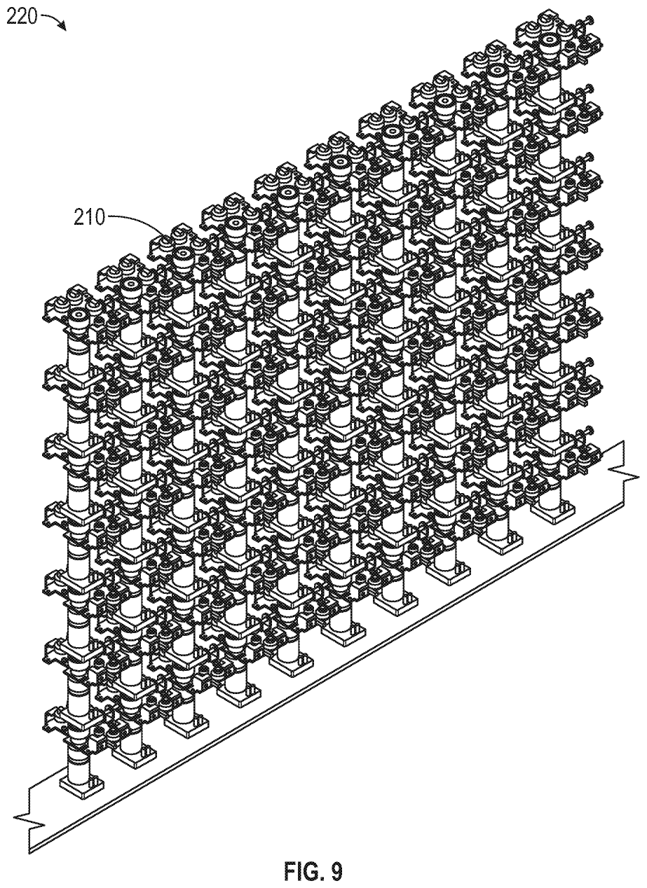

In some embodiments, shooter assemblies 210 may be arranged in one or more shooter assembly arrays 220, as shown in FIG. 9. In some embodiments, robotic manipulator system 100 may include shooter assemblies 210 arranged in shooter assembly arrays 220 additionally or alternatively to actuators 140 arranged in actuator grids 130. Shooter assembly array 220 may comprise any one or more features as described herein with respect to actuator grid 130. For example, a shooter assembly array 220 may comprise an arrangement of 30 or more, 35 or more, 40 or more, 50 or more, 60 or more, 100 or more, 200 or more, 300 or more, 900 or more, 1000 or more, 2000 or more, or 3000 or more shooter assemblies. In some embodiments, each shooter assembly array 220 may comprise less than 1000, less than 900, less than 800, less than 700, less than 600, less than 300, less than 200, less than 100, less than 60, less than 50, or less than 40 shooter assemblies 210. While FIG. 8 shows a shooter assembly array 220 comprising 70 shooter assemblies 210, it should be understood that shooter assembly array 220 can comprise an arrangement of any number of shooter assemblies 210 (e.g., between 35 to 1000, 35 to 900, 35 to 800, 35 to 700, 35 to 600, 35 to 500, 35 to 400, 35 to 300, 35 to 200, 35 to 100, 35 to 75, 50 to 1000, 75 to 1000, 100 to 1000, 200 to 1000, 300 to 1000, 400 to 1000, 500 to 1000, 600 to 1000, 700 to 1000, 800 to 1000, 900 to 1000). Shooter assemblies 210 may be modular, such that shooter assemblies 210 can be removed or added from the shooter assembly array 220.

While FIG. 9 shows shooter assembly array 220 comprising a rectangular arrangement of shooter assemblies 210 (e.g., an arrangement of 7 by 10 shooter assemblies 210), it should be understood that shooter assembly array 220 may comprise other shapes. For example, shooter assembly array 220 may comprise a square arrangement of slots (e.g., 30 by 30 shooter assemblies 210). In another example, shooter assembly array 220 may comprise a honeycomb shape. In some examples, shooter assembly array 220 may comprise shooter assemblies 210 arranged in concentric circles. While FIG. 5 shows shooter assembly array 220 comprising a planar top shape such that all the shooter assemblies 210 are arranged parallel to each other, it should be understood that shooter assembly array 220 may have a non-planar shape. For example, shooter assembly array 220 may comprise a concave or hemispherical shape.

In some embodiments, shooter assembly array 220 can be separate from the robotic appendage 110. For example, shooter assembly array 220 may be connected to the robotic appendage 110 only through the plurality of tendons 120. Separation of the shooter assembly array 220 from the robotic appendage 110 can allow larger space to house more shooter assemblies 210, allowing for control of more tendons 120 and increasing the degrees of freedom for robotic appendage 110.

In some embodiments, tendons 120 may comprise deformable materials that can contract in response to application of external stimuli (e.g., electric current, heat, magnetic field, etc.). For example, the one or more tendons may comprise shape memory alloys, thermoplastic elastomers, electroactive polymers, dielectric elastomers, piezoelectric polymers, or magnetostrictive materials. Robotic manipulator system can include heat sources, voltage sources, or magnetic field generators for each tendon 120 to cause selective contraction in the tendon 120. In some examples, actuators 140 or shooter assemblies 210 may comprise heat sources, voltage sources, or magnetic field generators. For example, motor brackets 148 of the actuators 140 may comprise heat sources, voltage sources, or magnetic field generators such that the motor bracket 148 can provide the heat, voltage, or magnetic field at the surface where the motor bracket 148 contacts the tendons 140. Optionally, the heat sources, voltage sources, or magnetic field generators may be arranged in an array separated from the actuator grid 130 or shooter assembly array 220. Optionally, the heat sources, voltage sources, or magnetic field generators may be integrated into an actuator grid 130 or shooter assembly array 220. Deformable tendons 120 can increase the degrees of freedom of robotic manipulator system 100.

A robotic manipulator system can include one or more arms to control the position of one or more robotic appendages 110 or one or more grippers 160. Robotic manipulator systems having arms to position grippers 160 may be able to execute a wider variety of tasks than a robotic manipulator system without arms, and can be used in industrial and home environments. For example, in home applications, robotic manipulator systems having arms can be used perform automated cooking. In industrial settings, robotic manipulator systems having arms can be used to perform complex manipulation and handling tasks, such as chicken deboning or sheet metal deburring. In some examples, robotic manipulator systems can be mounted to stationary surfaces, such as a work bench. In other embodiments, robotic manipulator systems can be mounted to mobile platforms, such as an autonomous vehicle or a cart. Mounting a robotic manipulator system to a mobile platform can allow the robotic manipulator system to perform a wider range of applications. For example, in a home application, the robotic manipulator can not only cook, but can move throughout a kitchen to obtain ingredients from a fridge or a pantry. The robotic systems described herein are not limited to the above-mentioned tasks, and may be suitable for a wide range of industries, as discussed in further detail below.

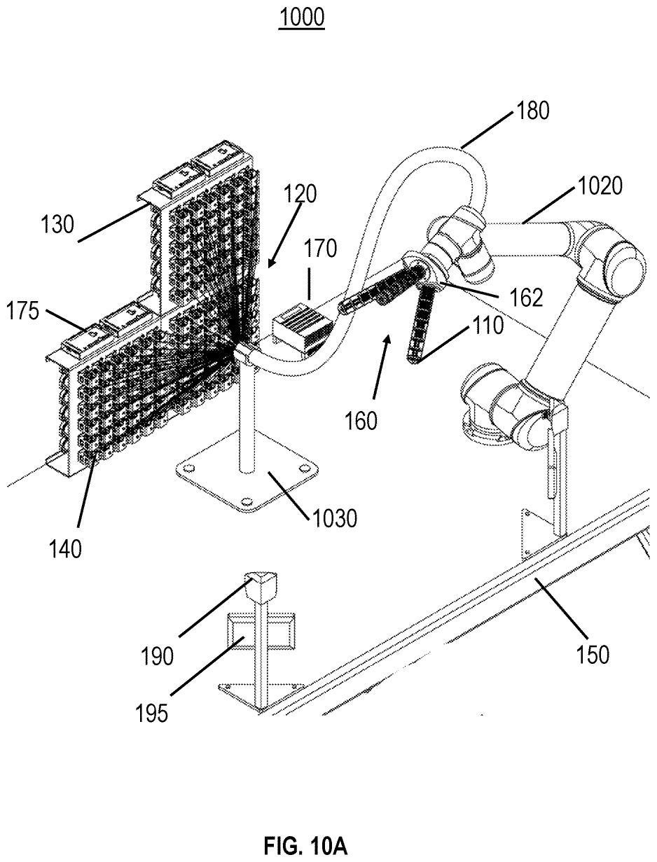

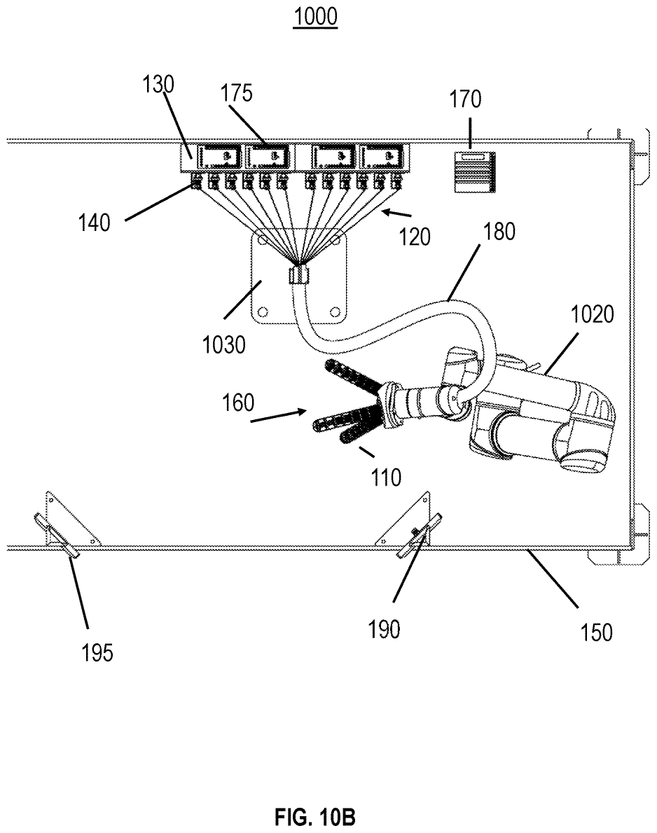

FIGS. 10A and 10B illustrate a perspective and top view, respectively, of an exemplary robotic manipulator system 1000 having an arm 1020 supporting an exemplary gripper 160 comprising three robotic appendages 110. Computing system 170 can be configured to control the motion of arm 1020. For example, computing system 170 can control arm 1020 to position gripper 160 in a desired location for performing a given task while also controlling each tendon 120 to manipulate gripper 160. In some embodiments, robotic manipulator system 100 can be mounted to a stationary surface, such as workbench 150. In some embodiments, robotic manipulator system 100 can be mounted to a mobile surface, such as an autonomous vehicle or cart. Exemplary robotic manipulator system 1000 can have a tube 180 extending from a support structure 1030 to the gripper base 162 of the gripper 160. Support structure 1030 can extend upwards from workbench 150 to provide support for the tube 180.

In some embodiments, actuator grids 130 can be positioned on workbench 150. Actuator grids 130 may be positioned vertically, such that the tendons 120 extend towards and into tube 180. In some embodiments, as shown in FIG. 10, actuator grids 130 may be stacked vertically to save space on workbench 150. Actuator control units 175 may be located on top of the stacked actuator grids 130 to enable accessibility.

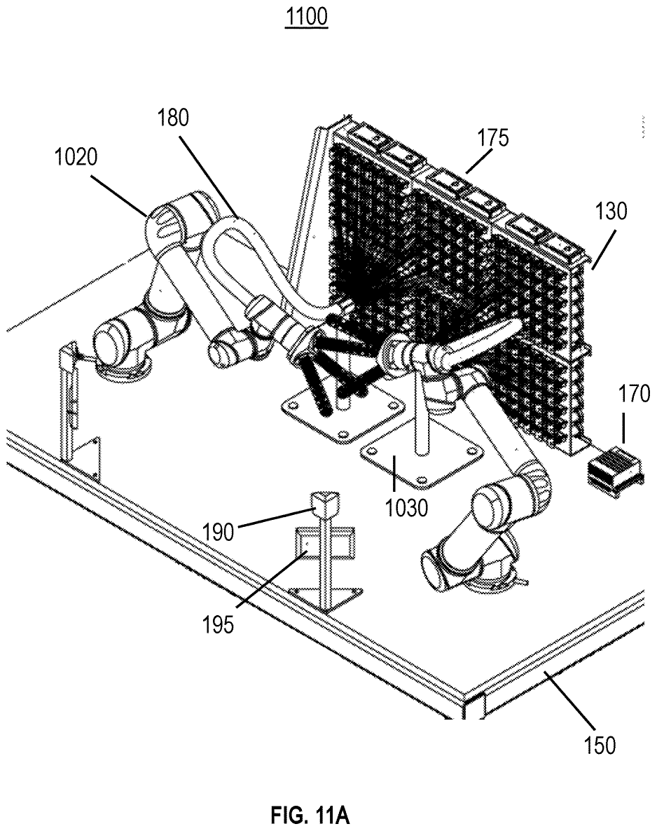

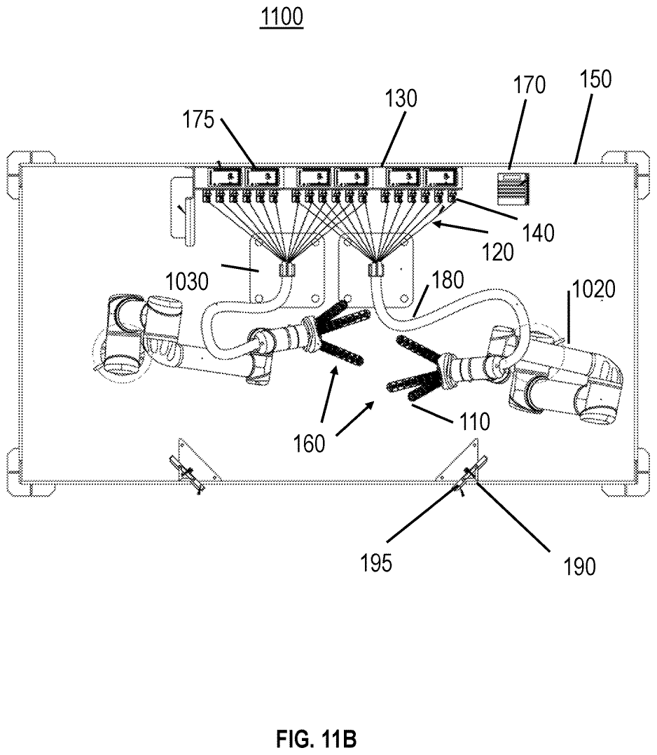

FIGS. 11A and 11B illustrate a perspective and top view, respectively, of another exemplary robotic manipulator system 1100 having a first robotic gripper 160 supported by a first arm 1020 and a second robotic gripper 160 supported by a second arm 1020. The first and second arms 1020 can be independently controlled by computing system 170. Robotic manipulator system 1100 can include 6 actuation grids 130, one for each robotic appendage 110 of the first and second grippers 160. Each of the 6 actuation grids can include 35-900 actuators 140 for individually actuating the 35-900 tendons in each robotic appendage 110. The plurality of tendons that control manipulation of the first gripper can be gathered in a first tube 180 extending from a first support structure 1030 to the gripper base 162 of the first gripper. The plurality of tendons that control manipulation of the second gripper can be gathered in a second tube 180 extending from a second support structure 1030 to the gripper base 162 of the second gripper.

While FIGS. 11A and 11B shows 2 grippers 160, each supported by an arm, it should be understood that a robotic manipulator system can include any number of grippers 160 (e.g., 1 or more, 2 or more, 3 or more, 4 or more, 5 or more, 10 or more, 15 or more, 20 or more, 50 or more), and some grippers 160 may be supported by an arm 1020 and some may not be supported by an arm 1020. In some embodiments, design limitations (e.g., space constraints in the environment or space constraints due to a given task) may limit the number of grippers 160 and/or arms 1020 (e.g., 50 or less, 40 or less, 30 or less, 20 or less, 15 or less, 10 or less, 9 or less, 8 or less, 7 or less, 6 or less, 5 or less, 4 or less, 3 or less).

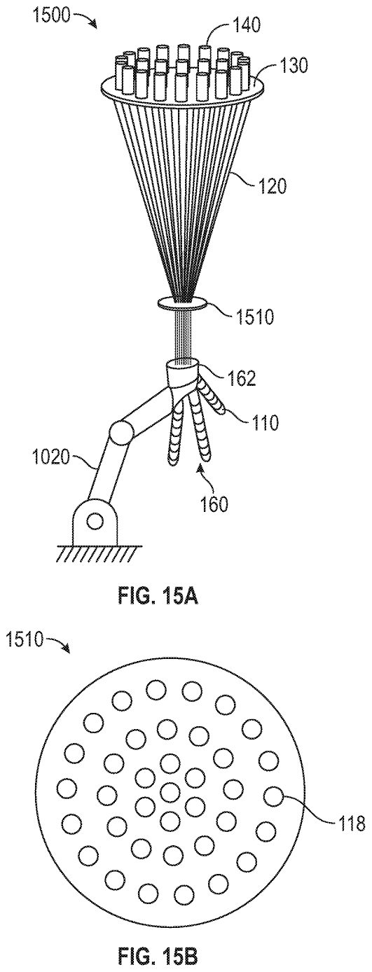

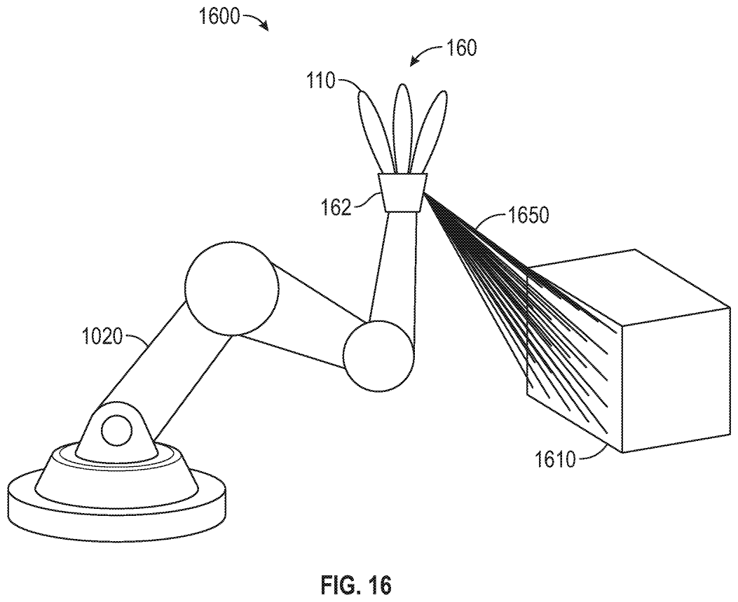

FIG. 15A shows a perspective view of another exemplary robotic manipulator system 1500 comprising a guide plate 1460 configured to guide tendons 120 from an actuator grid 130 to a robotic gripper 160 supported by an arm 1020. In some embodiments, robotic manipulator system 1500 may comprise one or more guide plates 1510 for reducing friction between tendons 120 by separating the tendons 120 from each other. Robotic manipulator system 1500 may comprise a guide plate 1510 additionally or alternatively to tubes 180 and/or metallic sleeves 1450. FIG. 15B shows a top views of an exemplary guide plate 1510 configured to guide tendons 120 from actuators 140 in an actuator grid 130 to a gripper or robotic appendage. Guide plate 1510 may comprise a plurality of routing apertures 118 configured to receive a tendon 120. Routing apertures 118 of guide plate 1510 may comprise any one or more features of routing apertures 118 of discs 114, as described above with respect to FIG. 2. Guide plate 1510 may be made of a smooth material such that there is little to no friction between the tendons 120 and the routing apertures 118.

While FIG. 15B shows the routing apertures arranged in concentric circles, it should be understood that the routing apertures can be arranged in any pattern (e.g., arranged in rows, arranged in a honeycomb configuration, etc.). While FIG. 15A and FIG. 15B show guide plate 1510 having a disc shape, it should be understood that guide plate 1510 can comprise any suitable shape (e.g., rectangular, triangular, hexagonal, or other polygonal shape). While FIG. 15A and FIG. 15B show guide plate 1510 as being planar, it should be understood that guide plate 1510 may be non-planar (e.g., convex or concave).

Friction between the tendons 120 and the guide plate 1460 may be minimized when the tendons 120 enter the routing apertures 118 of guide plate 1510 at a perpendicular angle. In some embodiments, for a robotic manipulator system configured to perform tasks where a gripper or robotic appendage do not need to move far (e.g., when a gripper is fixed to a surface) the guide plate 1510 can be fixed relative to the actuator grid 130 and actuators 140 such that guide plate 1510 and actuator grid 130 are parallel to each other and the tendons 120 can enter the routing apertures 118 at a substantially perpendicular angle. For example, an actuator grid 130 can be fixed at a location above a guide plate 1510, such that tendons 120 enter the routing apertures 118 of guide plate 1510 from the top and are directed to a gripper or robotic appendage below. In some embodiments, for a robotic manipulator system 100 configured to perform tasks where a gripper or robotic appendage do move (e.g., robotic system 1500 where a gripper or robotic appendage are mounted on a robotic arm), the guide plate 1510 may be configured to be actuatable, such that guide plate 1510 can rotate, tilt, or move such that guide plate 1510 and actuator grid 130 are parallel to each other and the tendons 120 can enter the routing apertures 118 at a substantially perpendicular angle. In some embodiments, the actuator grid 130 may be actuatable such that tendons 120 can enter the routing apertures 118 at a substantially perpendicular angle. A substantially perpendicular angle may vary from a perpendicular angle (e.g., 90 degrees) by less than 40 degrees, less than 30 degrees, less than 20 degrees, less than 10 degrees, or less than 5 degrees.

While FIG. 15A shows one guide plate 1510, it should be understood that a robotic manipulator system may comprise a plurality of guide plates 1510. For example, a robotic manipulator system may comprise a plurality of guide plates arranged in series, arranged in parallel and receiving different groups of tendons 120, and/or a combination thereof. The guide plates 1510 can reduce friction by increasing the angle between a tendon 120 entering the guide plate 1510 and the tendon 120 leaving the disk 1510 (e.g., such that the tendons may not have to take sharp turns which may increase friction, wear, and tear). For example, having more than one guide plate 1510 may smooth out the angle of a tendon 120 in multiple stages.

FIG. 16 shows a perspective view of another exemplary robotic manipulator system 1600 comprising a pneumatic or hydraulic actuator system 1610 configured to control actuation of a plurality of hydraulic or pneumatic mechanisms of robotic appendages 110 of a gripper 160. Except for actuators 140 and actuator grid 130, robotic system 1600 may comprise any one or more features of robotic systems 100, 1000, 1100, or 1500. For example, gripper 160 may be mounted on an arm 1020.

Hydraulic and pneumatic systems use fluids (liquids for hydraulic or gases for pneumatic) to transmit power and perform work (e.g., using pistons). For example, distal ends of tendons 120 of the robotic appendages 110 may be engaged to pistons located at the base of the robotic appendages 110 or the gripper 160, such that actuation of the pistons causes an increase or decrease in tension in the tendons 120. Pneumatic and hydraulic transmission can occur within flexible tubes 1650 that can extend from the pneumatic or hydraulic actuator system 1610 to the pistons at the base of gripper 160 or robotic appendages 110. Since actuation occurs within the tubes 1650, there is no friction between the pneumatic or hydraulic actuator system 1610 to the gripper 160 or robotic appendages 110.

Pneumatic or hydraulic actuator system 1610 may comprise a pump (for a hydraulic system), a compressor (for a pneumatic system), valves, and a reservoir to contain fluid. Pneumatic or hydraulic actuator system 1610 may engage the proximal ends of the flexible tubes 1650. The distal end of each flexible tube 1650 may comprise an actuator (e.g., piston) for actuation of a tendon 120. Since tendons 120 may be coupled to flexible tubes 1650 and pistons in a one to one ration, the robotic manipulator system 1600 may comprise a large number of flexible tubes and pistons per robotic appendage 110 (e.g., 30 or more, 35 or more, 40 or more, 50 or more, 60 or more, 100 or more, 200 or more, 300 or more, 900 or more, 1000 or more, 2000 or more, or 3000 or more) In some embodiments, design limitations (e.g., space constraints in the environment or space constraints due to a given task) may limit the number of flexible tubes 1650 and pistons per robotic appendage 110 (e.g. less than 1000, less than 900, less than 800, less than 700, less than 600, less than 300, less than 200, less than 100, less than 60, less than 50, or less than 40).

FIGS. 17A and 17B show perspective and top views, respectively, of another exemplary robotic manipulator system 1700 comprising a gripper 1710. Gripper 1710 can have any one or more features of gripper 160, except that gripper 1710 may not comprise a gripper base 162 and may instead comprise a plurality of robotic appendages 110 (or 1300) mounted on a surface 1710. Surface 1710 may be supported by a plurality of supports 1720 such that planar surface 1710 is suspended above one or more actuator grids 130. While FIGS. 17A and 17B show gripper 1710 as having 3 robotic appendages 110, it should be understood that a gripper 1710 can have any number of robotic appendages 110, as described above with reference to gripper 160.

As shown in FIGS. 17A and 17B, robotic manipulator system 1700 may comprise hexagonal actuator grids 130 with actuators 140 arranged in a honeycomb (e.g., hexagonal) arrangement. While FIGS. 17A and 17B do not show the tendons 120 extending from the robotic appendage 110 and gripper 1710 to the actuators 140 in actuator grid 130 for illustrative purposes, it should be understood that the distal ends of tendons 120 are engaged to the actuators 140 in actuator grid 130. With the exception of gripper 160, robotic manipulator system 1700 may comprise any one or more features of robotic manipulator system 100. For example, actuator grid 130 may comprise an actuator control unit 175 configured to control actuation of the tendons 120 by generating a plurality of actuation signals for each actuator 140. Honeycomb may refer to any polygon shape.

The disclosed robotic manipulator systems can be used for a variety of tasks in a variety of fields. In some embodiments, the highly dexterous robotic manipulator system can be used as a surgical robot. For example, the robotic manipulator systems can be used to perform minimally invasive surgeries. The disclosed highly dexterous robotic manipulator systems may be well-suited to performing minimally invasive surgeries because it may be able to perform precise movements, allowing for complex maneuvers in tight spaces that human hands or conventional robots may struggle with. For example, the disclosed highly dexterous robotic manipulator systems may be used to operate miniature endoscopic tools with high precision. In some embodiments, the robotic manipulator systems can be used for manufacturing and assembly. For example, the disclosed highly dexterous robotic manipulator systems may be well suited to assembling intricate components (e.g., for electronics or automotives industries), where precision and flexibility may be desirous for handling small parts. In some embodiments, the disclosed robotic manipulator systems may be well suited for robotic prosthetics. For example, the ability of the disclosed system to precisely manipulate biological soft tissues may enable naturalistic movements and good integration with a human body and soft tissues. In some embodiments, the disclosed systems may be used as or integrated into wearable exoskeletons or other forms of human augmentation. In some embodiments, the highly dexterous robotic manipulator system can be used for research and exploration. For example, the disclosed systems can be used in hazardous environments (e.g., underwater or in space) and may perform tasks that require delicate handling (e.g., repairing satellites or other objects in zero-gravity). In some embodiments, the disclosed systems can be integrated with haptic feedback systems in virtual reality (VR) or augmented reality (AR) systems. The disclosed highly dexterous robotic systems may be able to provide realistic tactile sensations that correspond to virtual objects and environments within the VR or AR systems, making virtual interactions feel more lifelike.

The disclosed robotic manipulator systems may not be limited to the above mentioned fields, and may be well-suited for uses in other fields, including, but not limited to, manufacturing, food and agriculture, assembly, recycling and waste management, packaging, retail, cleaning, natural resource management, construction, maintenance, biotech, art and sculpture, food preparation, elderly care and assistance, telepresence and remote operations, education and training, or entertainment.

The disclosed robotic manipulator systems may not be limited to the above mentioned tasks, and may be well-suited for uses in other tasks, including, but not limited to, automotive assembly (wire harness assembly, installation of components including headlights, interiors, or wire harnesses), crop sorting and/or packaging (e.g., pear packing, pear repacking, tomato packing, tomato repacking), product assembly (e.g., of electronics, toys, furniture, household items, customized small-batch assembly), recycling, refurbishing tasks, quality control (e.g., sorting defects) electronics assembly and/or installation (e.g., assembling and/or installing batteries, computer hardware, camera calibration, laser calibration, cable harness installation), packaging (e.g., of consumer goods or fragile goods), space production (e.g., in agriculture), working in challenging environments (e.g., handling hazardous materials, handling biohazardous materials, work in extreme temperatures, work in sterile environments), butchery (chicken deboning, shrimp deveining, meat butchering), retail labor (e.g., restocking retail shelves, inventory counting, folding clothes, order fulfillment, dishwashing, mail delivery, mail sorting), textile manufacturing (e.g., clothing manufacturing, jewelry manufacturing, purse and accessories manufacturing), food preparation (e.g., meal kits, deli meat, packaged food assembly), cooking (e.g., in a restaurant, for meal assembly), cleaning (e.g., store cleaning, hotel cleaning, public space cleaning), biotech (e.g., preparing materials, handling materials), material extraction (e.g., mining, rubber harvesting, oil drilling, logging), building construction (e.g., wiring buildings, plumbing installation, framing, drywalling), greenhouse pruning and other greenhouse maintenance (e.g., for growing tomatoes, weeding, growing flowers), harvesting (e.g., honey extraction, mushroom cultivation and harvesting, or indoor/greenhouse harvesting), car mechanical maintenance (e.g., oil changing, light replacement, car cleaning, tire changing), electrical line repair (e.g., after hours preparation, cleaning, staging of food, manufacturing, or packaging), and/or agriculture scouting, sampling, and/or pruning (e.g., collecting soil samples, Brix testing, and/or insect scouting).

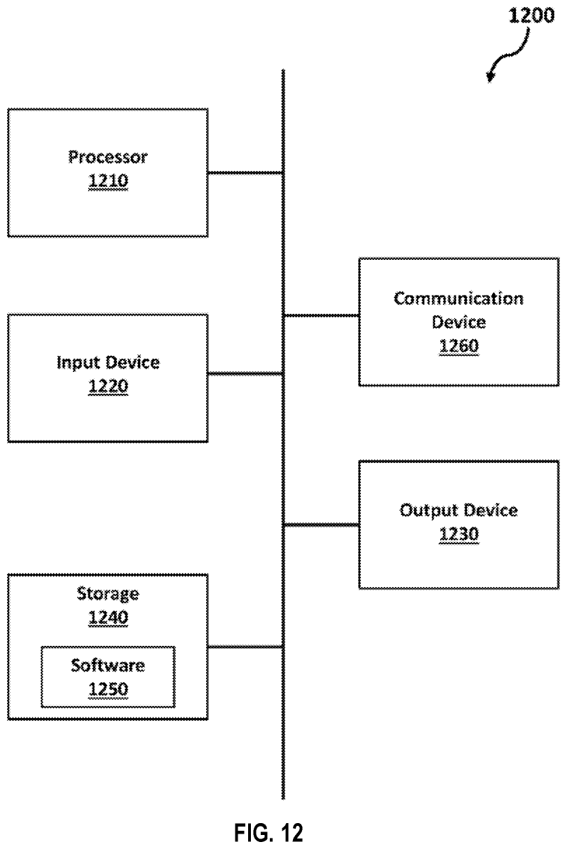

FIG. 12 depicts an exemplary computing device 1200 (e.g., computing system 170 or actuator control unit 175), that may be used for controlling a robotic manipulator system in accordance with one or more examples of the disclosure. Device 1200 can be a host computer connected to a network. Device 1200 can be a client computer or a server. As shown in FIG. 12, device 1200 can be any suitable type of microprocessor-based device, such as a personal computer, workstation, server, or handheld computing device (i.e., a portable electronic device) such as a phone or tablet. The device can include, for example, one or more of processors 1210, input device 1220, output device 1230, storage 1240, and communication device 1260. Input device 1220 and output device 1230 can generally correspond to those described above and can either be connectable or integrated with the computer.

Input device 1220 can be any suitable device that provides input, such as a touch screen, keyboard or keypad, mouse, or voice-recognition device. Output device 1230 can be any suitable device that provides output, such as a touch screen, haptics device, or speaker.

Storage 1240 can be any suitable device that provides storage, such as an electrical, magnetic, or optical memory, including a RAM, cache, hard drive, or removable storage disk. Communication device 1260 can include any suitable device capable of transmitting and receiving signals over a network, such as a network interface chip or device. The components of the computer can be connected in any suitable manner, such as via a physical bus or wirelessly.

Software 1250, which can be stored in storage 1240 and executed by processor 1210, can include, for example, the programming that embodies the functionality of the present disclosure (e.g., as embodied in the devices as described above).

Software 1250 can also be stored and/or transported within any non-transitory computer-readable storage medium for use by, or in connection with, an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1240, that can contain or store programming for use by, or in connection with, an instruction execution system, apparatus, or device.

Software 1250 can also be propagated within any transport medium for use by, or in connection with, an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by, or in connection with, an instruction execution system, apparatus, or device. The transport-readable medium can include, but is not limited to, an electronic, magnetic, optical, electromagnetic, or infrared wired or wireless propagation medium.

Device 1200 may be connected to a network, which can be any suitable type of interconnected communication system. The network can implement any suitable communication protocols and can be secured by any suitable security protocols. The network can comprise network links of any suitable arrangement that can implement the transmission and reception of network signals, such as wireless network connections, T1 or T3 lines, cable networks, DSL, or telephone lines.

Device 1200 can implement any operating system suitable for operating on the network. Software 1250 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

What is claimed is:

1. A robotic manipulator system comprising:
a robotic appendage comprising:
a support structure,
a series of discs arranged along a longitudinal axis of the support structure, and
a plurality of tendons extending through the series of discs, wherein a distal end of each tendon of the plurality of tendons is attached to the series of discs; and
an actuator grid comprising an arrangement of 35 or more actuators, each actuator of the 35 or more actuators engaging one or more proximal ends of one or more tendons of the plurality of tendons.

2. The system of claim 1, wherein the actuator grid comprises less than 900 actuators.

3. The system of claim 1, wherein the actuator grid is connected to the robotic appendage only through the plurality of tendons.

4. The system of claim 1, wherein the actuator grid comprises 35 or more slots for accommodating the 35 or more actuators.

5. The system of claim 1, wherein the actuator grid comprises a honeycomb shape.

6. The system of claim 1, wherein each actuator of the 35 or more actuators is removable from the actuator grid.

7. The system of claim 1, further comprising one or more tubes positioned in between the robotic appendage and the actuator grid, wherein each tube is configured to gather one or more tendons of the plurality of tendons.

8. The system of claim 7, wherein at least one tube of the one or more tubes comprises a lubricated interior surface configured to reduce frictional force between the gathered one or more tendons or between the gathered one or more tendons and the lubricated interior surface of the at least one tube.

9. The system of claim 6, wherein at least one tube of the one or more tubes gathers one or more tendons configured to produce frictional force between the gathered one or more tendons or between the gathered one or more tendons and an interior surface of the at least one tube during actuation of the gathered one or more tendons.

10. The system of claim 1, further comprising a pulley system positioned in between the robotic appendage and the actuator grid, wherein the pulley system engages the plurality of tendons such that each tendon is separated from other tendons in the plurality of tendons.

11. The system of claim 1, wherein the actuator grid comprises a concave surface.

12. The system of claim 1, wherein the robotic appendage further comprises a sleeve disposed around the series of discs and the support structure.

13. The system of claim 1, wherein the series of discs comprises a first disc and a second disc, wherein the first disc and the second disc are different in shape, size, width, depth, height, material, or concavity, or any combination thereof.

14. The system of claim 1, wherein at least one tendon of the plurality of tendons extends through the series of discs in a helical manner.

15. The system of claim 1, wherein the actuator grid comprises at least one actuator control unit configured to generate a plurality of actuation signals for each actuator of the 35 or more actuators, wherein each actuator is configured to actuate one or more tendons based on a received actuation signal of the plurality of actuation signals.

16. The system of claim 15, wherein the at least one control unit is configured to generate the plurality of actuation signals based on a control signal received from a machine learning model configured to generate the control signal based on a determination of which tendons of the plurality of tendons to actuate to execute a given task.

17. The system of claim 16, wherein the given task is chicken deboning, wire harness manufacturing, taping, removing tape, or fabric manufacturing.

18. The system of claim 1, wherein at least one actuator of the 35 or more actuators comprises:
a capstan securing a proximal end of one or more tendons of the plurality of tendons; and
a motor coupled to the capstan, wherein the motor is configured to rotate the capstan to decrease or increase tension of the one or more tendons.

19. The system of claim 1, wherein each disc of the series of discs comprises a plurality of routing apertures for receiving one or more tendons of the plurality of tendons.

20. The system of claim 1, wherein the actuator grid is a first actuator grid, and the 35 or more actuators are a first 35 or more actuators, the system further comprising a second actuator grid configured to house a second 35 or more of actuators.
